(19) United States
(12) Patent Application Publication
(10) Pub. No.: US 2026/0000028 A1
(43) Pub. Date: Jan. 1, 2026

(54) GRAIN CART CONTROL SPOUT AND RELATED METHODS

(71) Applicant: J. & M. Manufacturing Co., Inc., Ft. Recovery, OH (US)

(72) Inventors: Dustan Grieshop, Ft. Recovery, OH (US); Ryan Kaiser, Ft. Recovery, OH (US)

(21) Appl. No.: 19/332,314

(22) Filed: Sep. 18, 2025

Related U.S. Application Data
(63) Continuation of application No. PCT/US2024/021991, filed on Mar. 28, 2024.
(60) Provisional application No. 63/455,369, filed on Mar. 29, 2023.

(51) Int. Cl. A01D 90/10; B65G 67/22; G01S 13/42; G05D 1/656; G05D 105/15

(52) U.S. Cl. CPC A01D 90/10; B65G 67/22; G01S 13/42; G05D 1/665; B65G 2201/042; B65G 2203/0283; B65G 2203/041; B65G 2203/042; B65G 2814/0247; B65G 2814/0302; B65G 2814/0344; G05D 2105/15

(57) ABSTRACT

A grain cart includes a supplying container and a grain transfer element coupled to and configured to receive grain from the supplying container. The grain transfer element is inclined upwardly, forwardly, and laterally outwardly from the supplying container. A control spout is coupled to and projects laterally outwardly from the grain transfer element. A first control spout actuator is configured to move the control spout about a first axis between a forward discharge direction and a rearward discharge direction to direct discharged grain forwardly and rearwardly into a receiving container. A second control spout actuator is configured to move the control spout about the second axis between a generally downward discharge direction and a laterally outward discharge direction to direct the discharged grain generally downwardly and laterally outwardly into the receiving container.

### CROSS REFERENCE TO RELATED APPLICATIONS

This application is a continuation of PCT Patent Application No. PCT/US2024/021991 filed Mar. 28, 2024, which claims the priority of U.S. Provisional Patent Application No. 63/455,369 filed Mar. 29, 2023, the disclosures of which are incorporated herein by reference in their entirety.

This application is also generally related to the subject matter disclosed in U.S. patent application Ser. No. 18/107,147 filed on Feb. 8, 2023, and U.S. patent application Ser. No. 18/793,594 filed on Aug. 2, 2024, the disclosures of which are hereby incorporated by reference in their entirety.

### TECHNICAL FIELD

The present disclosure generally relates to devices for agricultural harvesting equipment and, more particularly, to systems for transferring harvested grain, and related methods.

### BACKGROUND

Harvesting operations for some agricultural materials, such as grains, may involve transferring harvested grain into containers for transport. For example, a combine harvester may separate the grain from the other portions of the plant and may discharge the harvested grain into a container for transport. In some circumstances, the combine may discharge the harvested grain directly into a gravity wagon or a grain hopper trailer of a tractor-trailer for transport via roads. In other circumstances, the combine may discharge the harvested grain into a grain cart, which may be used to transport the grain across the field, such as to a road, where the grain cart is unloaded into a gravity wagon or a grain hopper trailer of a tractor-trailer for transport via roads.

Grain carts are usually pulled by a tractor for transporting grain from a harvesting combine in a field to an open top grain hopper trailer which transports the grain over the road to a grain elevator for drying and storage. Grain carts include a grain container, such as a grain hopper, for holding the harvested grain and a grain transfer element for unloading the grain from the grain cart. Some grain carts have an angled inclined grain transfer element, such as an auger conveyor, which extends upward from the bottom of the grain container, forward from a front wall of the grain container, and laterally outward from a side wall of the grain container. Carts with grain transfer elements oriented in this manner are often called corner auger carts due to the grain transfer element being generally aligned with a corner of the grain container. By extending upwardly, laterally outwardly, and forwardly from the grain container, the grain transfer element may be conveniently viewed by the driver of the tractor while unloading grain from the grain cart.

When grain is unloaded from a grain cart and discharged into an open top rectangular grain hopper trailer, for example, the grain is discharged from the grain transfer element through a discharge spout. On many grain carts the discharge spout is aligned with the grain transfer element. Due to the alignment of the discharge spout, the grain may be discharged at an angle to the longitudinal axis or centerline of the grain hopper trailer, i.e., not parallel or perpendicular to the longitudinal axis or centerline of the grain hopper trailer. If the grain is discharged at an angle to the longitudinal axis of the grain hopper trailer, all four corners of the grain hopper trailer may not be completely filled with grain. To completely fill the corners of the grain hopper trailer, a person might climb into the trailer or onto a wall of the trailer and manually pull or move the grain into the corners of the trailer with a shovel, rake, or other tool. This manual operation is time consuming, physically demanding, and includes risk of injury. If the grain is not manually moved to fill up the corners, portions of the trailer are not topped off with grain, and less than a full load of grain will be delivered to the grain elevator, for example. Partially loaded trailers decrease efficiency and may require more loads of grain to be hauled, increasing the time and cost of harvest operations.

Some grain carts are equipped with discharge spouts that may be moved from a generally downward discharge direction to an outward discharge direction aligned with the axis of the grain transfer element. The movement of the discharge spout aligned with the axis of the grain transfer element allows the grain to be directed into different portions of the grain hopper trailer, for example. Some grain carts are equipped with discharge spouts that may be rotated around the axis of the grain transfer element. The rotation of the discharge spout on the axis of the grain transfer element allows the grain to be directed into different portions of the grain hopper trailer, for example. When using a discharge spout with a rotation function, the grain is discharged in an arc which may direct the grain away from its previous position relative to the sides of the trailer. To maintain the grain discharge in the same position relative to the sides of the trailer, the operator would need to rotate the discharge spout and move the move the discharge spout in or out at the same time, which is difficult and increases opportunity for user error. Some grain carts are equipped with discharge spouts that may be both moved from a generally downward discharge direction to an outward discharge direction aligned with the axis of the grain transfer element and rotated around the axis of the grain transfer element. Due to misalignment of the axis of the grain transfer element to the longitudinal axis of the grain hopper trailer, it can remain difficult for an operator to fill all four corners of a grain hopper trailer. This misalignment of the grain transfer element and grain hopper trailer axes also makes the control of the discharge spout itself more difficult for the operator, as the directional controls for directing the discharge spout are not naturally intuitive for an operator. This misalignment of the axes increases the risk of an operator directing the spout in an unintended direction and increases the possibility of spilling grain.

The present disclosure contemplates that each grain transfer operation involves the potential for operator error. For example, it is not uncommon that an operator of a grain cart, while unloading grain into a grain hopper trailer with a grain transfer element, intends to perform an operation with one of the hydraulic levers of the tractor, but activates the wrong hydraulic lever by mistake. For example, the operator may be controlling the direction of a grain discharge spout while transferring grain into a receiving container. As described above, the axis of the grain transfer element may not be aligned with the longitudinal axis of the grain cart. This misalignment of the axes makes the control of the discharge spout more difficult for the operator, increasing the risk of directing the spout in an unintended direction. A wrongly activated hydraulic lever may unintentionally change the direction of the discharge spout thereby causing the discharge spout to discharge grain in an unintended direction. At this point, the costly grain being discharged through the discharge spout may miss the grain hopper trailer and spill onto the ground. If the operator notices the mistake, the operator may compound the error by attempting to move the discharge spout in another direction using controls that move the spout in directions that are not aligned with the longitudinal axis of the grain hopper trailer, possibly spilling even more grain.

Some grain carts include automated unloading systems. As described above, the axis of the grain transfer element may not be aligned with the longitudinal axis of the grain cart. This misalignment of the axes complicates the automated control of the discharge spout, increasing the risk of directing the spout in an unintended direction, and/or incomplete filling of the grain hopper trailer. Since automated unloading systems are generally programed to avoid discharging grain in an unintended direction or overfilling any portion of a receiving container, the system will likely stop discharging grain to avoid the risk of spilling the grain.

The above-described issues have been partially addressed in U.S. Pat. No. 9,113,598 which discloses a control spout mounted to a grain transfer element at an askewed angle and projecting laterally away from the grain cart. The control spout is configured for tilting movement on a substantially horizontal axis which is substantially parallel to a side wall of the grain cart. Mounting the control spout in this manner helps to align the discharge spout generally perpendicular to the longitudinal axis of the grain hopper trailer or other rectangular receiving container. Further, the control spout disclosed in U.S. Pat. No. 9,113,598 may be moved from a generally downward discharge direction to an outward discharge direction in a plane that is generally perpendicular to the longitudinal axis of the grain hopper trailer. The alignment and movement of the control spout improves the ability of an operator to evenly fill a grain hopper trailer. However, to fill the entire length of the grain hopper trailer, an operator must move the grain cart along the length of the grain hopper trailer while controlling the unloading of the grain and directing the control spout.

Accordingly, and despite the various advances already made in this field, there is a need for further improvements related to grain discharge spouts, as well as systems and methods, for transferring harvested grain into transport containers.

### SUMMARY

In at least some embodiments the present disclosure describes a control spout that is aligned with the trailer and includes a swivel function that improves the ease of use for the operator. Generally, operators unload grain into the grain trailer along the longitudinal centerline of the trailer. The new swivel function does not change the grain discharge point relative to the sides of the trailer. The swivel function only affects the discharge point relative to the front and rear of the trailer, which makes it much easier for the operator to control the discharge of the grain forwards and rearwards relative to the front and rear of the trailer while maintaining the discharge point in along the longitudinal centerline of the trailer thereby minimizing risk of spilling grain.

Generally, a grain cart configured for transferring grain to a receiving container, is provided. The cart includes a supplying container, a grain transfer element, a control spout, a first control spout actuator, and a second control spout actuator. The supplying container is configured to receive grain and includes a left side wall and a right side wall connected by a front wall and a rear wall. The grain transfer element is coupled to the supplying container and is configured to receive grain from the supplying container. The grain transfer element is inclined upwardly, forwardly of the front wall of the supplying container, and laterally outwardly of the left side wall or the right side wall of the supplying container. The control spout is coupled to and projects laterally outwardly from the grain transfer element. The control spout is configured for movement about a first axis and a second axis. The control spout is also configured to receive grain from the grain transfer element and to discharge and direct the grain into the receiving container. The first control spout actuator is coupled to the control spout and is configured to move the control spout about the first axis between a forward discharge direction and a rearward discharge direction. The second control spout actuator is coupled to the control spout and is configured to move the control spout about the second axis between a generally downward discharge direction and a laterally outward discharge direction. Moving the control spout between the forward discharge direction and the rearward discharge direction directs the discharged grain forwardly and rearwardly into the receiving container. Moving the control spout between the generally downward discharge direction and the laterally outward discharge direction directs the discharged grain generally downwardly and laterally outwardly into the receiving container.

In some embodiments, the grain cart may include a swivel joint rotatably coupling the control spout to the grain transfer element. The first control spout actuator may be coupled to at least one of the swivel joint or the control spout. The second control spout actuator may be coupled to at least one of the swivel joint or the control spout. The control spout may have a control spout inlet section coupled to the grain transfer element and a control spout outlet section movably coupled to the control spout inlet section. The control spout outlet section may move between the generally downward discharge direction and the laterally outward discharge direction. The second spout actuator may be coupled to at least one of the control spout inlet section or the control spout outlet section. The control spout inlet section may have at least one side wall supporting the control spout outlet section. The control spout outlet section may include at least one side wall coupled to a side wall of the control spout inlet section. The control spout inlet section may include a bottom portion. The control spout outlet section may include a bottom portion. The bottom portion of the control spout outlet section may be coupled to the bottom portion of the control spout inlet section. The grain cart may have a discharge spout including a discharge spout outlet where the discharge spout may be coupled to the grain transfer element. The control spout may be coupled to the discharge spout outlet and the discharge spout outlet may project laterally outwardly from the auger housing. The grain cart may include a floor auger in the supplying container configured to move grain in the supplying container toward the grain transfer element.

The grain cart may have a control system for directing the movement of the control spout. The control system may include a processor. The processor may be configured to direct the first control spout actuator to move the control spout between the forward discharge direction and the rearward discharge direction. The processor may be configured to direct the second control spout actuator to move the control spout between the generally downward discharge direction and the laterally outward discharge direction.

In some embodiments, the control system may include a control spout position sensor configured to detect a position of the control spout and provide a signal to the processor, and the processor may direct the movement of the control spout based at least in part on the signal from the control spout position sensor. The control system may include at least one receiving container sensor configured to detect at least a portion of an upper perimeter of the receiving container and at least a portion of an upper surface of a grain mound in the receiving container and provide a signal to the processor. The receiving container sensor may further comprise a first receiving container sensor configured to detect at least a portion of the upper perimeter of the receiving container and provide a signal to the processor and a second receiving container sensor configured to detect at least a portion of the upper surface of the grain mound in the receiving container and provide a signal to the processor. In other words, the same receiving container sensor(s) may be used to detect the receiving container itself and the grain it contains and/or different receiving container sensors may be used for these purposes. The processor may be configured to compare the detected portion of the upper perimeter and the detected portion of the upper surface, and the processor may direct the movement of the control spout based at least in part on a result of the comparison of the detected portion of the upper perimeter and the detected portion of the upper surface. Based at least in part on a result of the comparison of the detected portion of the upper perimeter and the detected portion of the upper surface, the processor may provide a perceptible indication to move at least one of the supplying container or the receiving container to position the control spout relative to the receiving container. The receiving container sensor may be at least one of a LIDAR scanner, a radar sensor, imaging radar sensor, a camera, a proximity sensor, a time-of-flight sensor, or a GPS receiver. The receiving container sensor may be configured to detect material differences between the grain and the receiving container. The processor may be configured to prevent discharge of grain via the control spout if the processor determines that grain discharged from the control spout would not be discharged into the receiving container. The processor may be configured to evaluate the location of the upper perimeter of the receiving container relative to the position of the control spout. The control system may be configured to notify a user of a status, position, and/or operation of the control spout.

An alternative grain cart configured for transferring grain to a receiving container includes a supplying container, a grain transfer element, a control spout, a swivel joint, a first control spout actuator, and a second control spout actuator. The supplying container is configured to receive grain and has a left side wall and a right side wall connected by a front wall and a rear wall. The grain transfer element is coupled to the supplying container and is configured to receive grain from the supplying container. The grain transfer element is inclined upwardly, forwardly of the front wall of the supplying container, and laterally outwardly of the left side wall or the right side wall of the supplying container. The control spout is configured for movement about a first axis and a second axis and projects laterally outwardly from the grain transfer element. The control spout is configured to receive grain from the grain transfer element and to discharge and direct the grain into the receiving container. The swivel joint rotatably couples the control spout to the grain transfer element. The first control spout actuator is coupled to at least one of the swivel joint or the control spout and is configured to move the control spout about the first axis between a forward discharge direction and a rearward discharge direction. The second control spout actuator is coupled to the control spout and is configured to move the control spout about the second axis between a generally downward discharge direction and a laterally outward discharge direction. Moving the control spout between the forward discharge direction and the rearward discharge direction directs the discharged grain forwardly and rearwardly into the receiving container. Moving the control spout between the generally downward discharge direction and the laterally outward discharge direction directs the discharged grain generally downwardly and laterally outwardly into the receiving container.

In some embodiments, the control spout may include a control spout inlet section coupled to the grain transfer element and a control spout outlet section movably coupled to the control spout inlet section. The control spout outlet section may move between the generally downward discharge direction and the laterally outward discharge direction. The second control spout actuator may be coupled to at least one of the control spout inlet section or the control spout outlet section. The control spout inlet section may include at least one side wall supporting the control spout outlet section. The control spout outlet section may include at least one side wall coupled to a side wall of the control spout inlet section. The control spout inlet section may have a bottom portion, and the control spout outlet section may have a bottom portion coupled to the bottom portion of the control spout inlet section. The grain cart may have a discharge spout coupled to the grain transfer element and including a discharge spout outlet. The control spout may be coupled to the discharge spout outlet. The discharge spout outlet may project generally laterally outwardly from the auger housing. The grain cart may include a floor auger in the supplying container configured to move grain in the supplying container toward the grain transfer element.

In alternative embodiments, the grain cart may include a control system for directing the movement of the control spout. The control system may include a processor configured to direct the first control spout actuator to move the control spout between the forward discharge direction and the rearward discharge direction and to direct the second control spout actuator to move the control spout between the generally downward discharge direction and the laterally outward discharge direction.

In some embodiments, the control system may include a control spout position sensor configured to detect a position of the control spout and provide a signal to the processor, and the processor may direct the movement of the control spout based at least in part on the signal from the control spout position sensor. The control system may include at least one receiving container sensor configured to detect at least a portion of an upper perimeter of the receiving container and at least a portion of an upper surface of a grain mound in the receiving container and provide a signal to the processor. The receiving container sensor may further comprise a first receiving container sensor configured to detect at least a portion of the upper perimeter of the receiving container and provide a signal to the processor and a second receiving container sensor configured to detect at least a portion of the upper surface of the grain mound in the receiving container and provide a signal to the processor. In other words, the same receiving container sensor(s) may be used to detect the receiving container itself and the grain it contains and/or different receiving container sensors may be used for these purposes. The processor may be configured to compare the detected portion of the upper perimeter and the detected portion of the upper surface, and the processor may direct the movement of the control spout based at least in part on a result of the comparison of the detected portion of the upper perimeter and the detected portion of the upper surface. Based at least in part on a result of the comparison of the detected portion of the upper perimeter and the detected portion of the upper surface, the control system may provide a perceptible indication to move at least one of the supplying container or the receiving container to position the control spout relative to the receiving container. The receiving container sensor may be at least one of a LIDAR scanner, a radar sensor, imaging radar sensor, a camera, a proximity sensor, a time-of-flight sensor, or a GPS receiver. The receiving container sensor may be configured to detect material differences between the grain and the receiving container. The processor may be configured to prevent discharge of grain via the control spout if the processor determines that grain discharged from the control spout would not be discharged into the receiving container. The processor may be configured to evaluate the location of the upper perimeter of the receiving container relative to the position of the control spout. The control system may provide a perceptible indication to move at least one of the supplying container or the receiving container to position the control spout relative to the receiving container. The control system may be configured to notify a user of a status, position, and/or operation of the control spout.

An automated grain unloading control system for a supplying container with a grain transfer element configured to transfer grain from the supplying container to a receiving container is provided. The control system includes a first sensor, a second sensor, and a processor. The first sensor may be at least one sensor configured to detect at least a portion of the receiving container and at least a portion of an upper surface of a grain mound in the receiving container. As mentioned herein, one or more sensors may be used to detect one or more portions of the receiving container and one or more of the same or different sensors may be used to detect the grain mound. The same holds true for other sensors mentioned herein. That is, it may be desirable or even required in some applications to use more than one sensor to adequately perform a detection function in a given application. The second sensor is configured to detect an orientation of the grain transfer element. The processor is configured to compare the detected portion of the receiving container, the detected portion of the upper surface, and the orientation of the grain transfer element, and control the operation of the grain transfer element to direct a transfer of grain from the supplying container to the receiving container based at least in part on a result of the comparison of the detected portion of the receiving container, the detected portion of the upper surface, and the orientation of the grain transfer element.

In some embodiments, at least one first sensor may be configured to detect an interface of an upper surface of a grain mound in the receiving container and a wall of the receiving container, and at least a portion of an upper edge of the wall. The processor may be configured to determine a plurality of freeboards by calculating a plurality of vertical distances between the detected interface and the detected portion of the upper edge of the wall. The processor may be configured to direct the transfer of grain based at least in part on the freeboards. The processor may determine a minimum freeboard by calculating a vertical distance between a highest point of the detected interface and a lowest point of the detected portion of the upper edge. The processor may determine a maximum freeboard by calculating a vertical distance between a lowest point of the detected interface and a highest point of the detected portion of the upper edge. The processor may direct the transfer of grain toward a portion of the receiving container with the maximum freeboard.

In alternative embodiments, the grain transfer element may include a movable spout configured to direct a stream of discharged grain. The second sensor may be configured to detect an orientation of the spout. The processor may be configured to control the movement of the spout to direct the stream of discharged grain. The spout may be movable to direct the stream of discharged grain laterally farther away from the supplying container and/or laterally nearer to the supplying container. The spout may be movable to direct the stream of discharged grain forwardly and/or rearwardly with respect to the supplying container. The processor may be configured to prevent a discharge of grain via the grain transfer element if the processor determines that the grain would not be discharged into the receiving container. The processor may be configured to provide a perceptible indication to move the supplying container to position the grain transfer element relative to the receiving container. The processor may be configured to evaluate a position of the grain transfer element relative to the receiving container. The processor may provide a perceptible indication to move the supplying container to position the grain transfer element relative to the receiving container based at least in part on the position of the grain transfer element relative to the receiving container. The processor may be configured to evaluate the position of the grain transfer element relative to the detected portion of the upper surface. The processor may provide a perceptible indication to move the supplying container to position the grain transfer element relative to the receiving container based at least in part on the position of the grain transfer element relative to the detected portion of the upper surface.

In alternative or additional aspects, at least one of the supplying container or the receiving container may include a scale element configured to detect a weight of the grain in the supplying container and/or the receiving container. The processor may be configured to direct the transfer of grain based at least in part on the weight of the grain in the supplying container and/or the receiving container. The receiving container may be divided into a plurality of compartments. The receiving container may include a scale element configured to detect a weight of the grain in at least one of the compartments. The processor may be configured to direct the transfer of grain based at least in part on the weight of the grain in at least one of the compartments of the receiving container. The supplying container may include a scale element configured to detect a weight of the grain in the supplying container. The processor may be configured to direct the transfer of grain based at least in part on the weight of the grain transferred into at least one of the compartments of the receiving container.

In some embodiments, the grain transfer element may include a grain transfer control element configured to adjust a grain transfer rate. The processor may be configured to control the grain transfer control element to adjust the grain transfer rate. The grain transfer control element may be a movable gate operatively interposing the supplying container and the grain transfer element, and the processor may be configured to direct the positioning of the gate. The receiving container may be divided into compartments. The compartments may be separated by one or more partitions. The first sensor may be configured to detect at least a portion of a partition and the controlled operation of the grain transfer element may be based at least in part on the detected portion of the partition. The receiving container may include one or more cross members. The at least one first sensor may be configured to detect at least a portion of the cross members, and the controlled operation of the grain transfer element may be based at least in part on the detected portion of the cross members. A grain cart, with a supplying container, such as a grain cart grain tank, may have a control system configured to transfer grain from the supplying container to a receiving container.

An alternative automated grain unloading control system for a supplying container with a grain transfer element configured to transfer grain from the supplying container to a receiving container is disclosed. The control system includes one or more sensors and a processor. The one or more sensors are configured to detect an orientation of the grain transfer element, at least a portion of the receiving container, and at least a portion of an upper surface of a grain mound in the receiving container. The processor is configured to compare the detected portion of the receiving container, the detected portion of the upper surface, and the orientation of the grain transfer element, and control the operation of the grain transfer element to direct a transfer of grain from the supplying container to the receiving container based at least in part on a result of the comparison of the detected portion of the receiving container, the detected portion of the upper surface, and the orientation of the grain transfer element.

In some embodiments, the one or more sensors may be configured to detect an interface of an upper surface of a grain mound in the receiving container and a wall of the receiving container, and at least a portion of an upper edge of the wall. The processor may be configured to determine a plurality of freeboards by calculating a plurality of vertical distances between the detected interface and the detected portion of the upper edge of the wall. The processor may be configured to direct the transfer of grain based at least in part on the freeboards. The processor may be configured to determine a minimum freeboard by calculating a vertical distance between a highest point of the detected interface and a lowest point of the detected portion of the upper edge. The processor may be configured to determine a maximum freeboard by calculating a vertical distance between a lowest point of the detected interface and a highest point of the detected portion of the upper edge. The processor may be configured to direct the transfer of grain toward a portion of the receiving container with the maximum freeboard.

In some embodiments, the grain transfer element may include a movable spout configured to direct a stream of discharged grain. The one or more sensors may be configured to detect an orientation of the spout. The spout may be movable to direct the stream of discharged grain laterally farther away from the supplying container and/or laterally nearer to the supplying container. The spout may be movable to direct the stream of discharged grain generally forwardly and/or generally rearwardly with respect to the supplying container. The processor may be configured to control the orientation of the spout to direct the stream of discharged grain. The processor may be configured to prevent a discharge of grain via the grain transfer element if the processor determines that the grain would not be discharged into the receiving container. The processor may be configured to provide a perceptible indication to move the supplying container to position the grain transfer element relative to the receiving container. The processor may be configured to evaluate a position of the grain transfer element relative to the receiving container, and the processor may provide a perceptible indication to move the supplying container to position the grain transfer element relative to the receiving container based at least in part on the position of the grain transfer element relative to the receiving container. The processor may be configured to evaluate the position of the grain transfer element relative to the detected portion of the upper surface, and the processor may provide a perceptible indication to move the supplying container to position the grain transfer element relative to the receiving container based at least in part on the position of the grain transfer element relative to the detected portion of the upper surface. The grain transfer element may include a grain transfer control element configured to adjust a grain transfer rate. The processor may be configured to control the grain transfer control element to adjust the grain transfer rate. The grain transfer control element may include a movable gate operatively interposing the supplying container and the grain transfer element. The processor may be configured to direct positioning of the gate.

In alternative embodiments, the supplying container may include a scale element configured to detect a weight of the grain in the supplying container. The receiving container may include a scale element configured to detect a weight of the grain in the receiving container. The processor may be configured to direct the transfer of grain based at least in part on the weight of the grain in at least one of the supplying container or the receiving container. The receiving container may be divided into a plurality of compartments. The receiving container may include a scale element configured to detect a weight of the grain in at least one of the compartments. The processor may be configured to direct the transfer of grain based at least in part on the weight of the grain in at least one of the compartments of the receiving container. The processor may be configured to direct the transfer of grain based at least in part on the weight of the grain transferred into at least one of the compartments of the receiving container. The receiving container may be divided into compartments. The compartments may be separated by one or more partitions. The one or more sensors may be configured to detect at least a portion of a partition. The controlled operation of the grain transfer element may be based at least in part on the detected portion of the partition. The receiving container may include one or more cross members. The one or more sensors may be configured to detect at least a portion of the cross members. The controlled operation of the grain transfer element may be based at least in part on the detected portion of the cross members.

Generally, a method of operating a control spout includes directing a first control spout actuator to move the control spout between a forward discharge direction and a rearward discharge direction, and directing a second control spout actuator to move the control spout between a generally downward discharge direction and a laterally outward discharge direction.

In some embodiments, the method of operating a control spout may include detecting a position of the control spout and directing at least one of the first or second control spout actuators based at least in part on the detected position of the control spout. The method may include detecting at least a portion of an upper perimeter of a receiving container, detecting at least a portion of an upper surface of a grain mound in the receiving container, comparing the detected portion of the upper perimeter and the detected portion of the upper surface, and directing at least one of the first or second control spout actuators based at least in part on a result of the comparison of the detected portion of the upper perimeter and the detected portion of the upper surface. The method may include detecting a position of at least one of the first or second control spout actuators, and directing at least one of the first or second control spout actuators based at least in part on the detected position of at least one of the first or second control spout actuators.

Generally, a method of operating an automated grain unloading control system includes operating at least one first sensor to detect at least a portion of a receiving container and at least a portion of an upper surface of a grain mound in the receiving container, operating a second sensor to detect an orientation of a grain transfer element, and transferring grain from a supplying container to the receiving container based at least in part on a comparison of the detected portion of the receiving container, the detected portion of the upper surface, and the orientation of the grain transfer element.

In some embodiments, the method of operating an automated grain unloading control system may include detecting an interface between an upper surface of a grain mound in the receiving container and a wall of the receiving container, detecting at least a portion of an upper edge of the wall, and determining a plurality of freeboards by calculating a plurality of vertical distances between the detected interface and the detected portion of the upper edge of the wall. The method may include determining a minimum freeboard by calculating a vertical distance between a highest point of the detected interface and a lowest point of the detected portion of the upper edge, determining a maximum freeboard by calculating a vertical distance between a lowest point of the detected interface and a highest point of the detected portion of the upper edge, and directing the transfer of grain toward a portion of the receiving container with the maximum freeboard. The method may include slowing down and/or stopping transferring grain upon determining that the freeboard is less than a predetermined freeboard minimum limit. The method may include preventing a discharge of grain if the grain would not be discharged into the receiving container.

In alternative or additional aspects, the method of operating an automated grain unloading control system may include receiving a maximum unload weight limit, detecting a weight of grain unloaded, and stopping transferring grain upon determining that the weight of grain unloaded has reached the maximum unload weight limit. The method may include slowing and/or or stopping the transfer of grain, and providing a perceptible indication of the cause of the slowing and/or or stopping of the transfer of grain. The method may include slowing and/or or stopping the transfer of grain, and providing a perceptible indication of actions to perform to resume the transfer of grain.

In some instances, the receiving container may be divided into compartments. The compartments may be separated by one or more partitions. The method of operating an automated grain unloading control system may include receiving a maximum weight limit of a compartment, detecting a weight of grain unloaded, and stopping and/or directing the transfer of grain upon determining that the weight of grain unloaded into the compartment has reached the weight limit of the compartment. The method may include providing a perceptible indication to move the supplying container to position the grain transfer element relative to the receiving container. The method may include detecting at least a portion of a partition and transferring grain from the supplying container to the receiving container based at least in part on the detected portion of the partition. The receiving container may include one or more cross members. The method may include detecting at least a portion a cross member and transferring grain from the supplying container to the receiving container based at least in part on the detected portion of the cross member.

In other embodiments, the grain transfer element may include a movable spout. The method of operating an automated grain unloading control system may include moving the spout to direct the stream of discharged grain laterally farther away from the supplying container and/or laterally nearer to the supplying container. The method may include moving the spout to direct the stream of discharged grain generally forwardly and/or generally rearwardly with respect to the supplying container.

The devices, systems, and/or methods disclosed herein may include any combination of apparatus, elements, and/or methods disclosed herein. Additional features and advantages of the inventive aspects will become more apparent upon review of the following detailed description taken together with accompanying drawings of the illustrative and exemplary embodiments.

### BRIEF DESCRIPTION OF THE DRAWINGS

FIG. 1 is a perspective view of an illustrative grain cart coupled to a tractor and transferring harvested grain to a grain hopper trailer coupled to a semi-tractor parked on a road adjacent to a field

FIG. 2 is a side elevation view of the grain cart of FIG. 1.

FIG. 3 is a plan view of the grain cart of FIGS. 1 and 2.

FIGS. 4 and 5 are front and rear elevation views respectively of the grain cart of FIGS. 1, 2, and 3.

FIGS. 6A, 6B, and 6C are side, front, and rear elevation views respectively showing an illustrative control spout in a downward and neutral orientation.

FIGS. 7A, 7B, and 7C are side, front, and rear elevation views respectively showing an illustrative control spout in a downward and rearward orientation.

FIGS. 8A, 8B, and 8C are side, front, and rear elevation views respectively showing an illustrative control spout in a downward and forward orientation.

FIGS. 9A, 9B, and 9C are side, front, and rear elevation views respectively showing an illustrative control spout in an outward and neutral orientation.

FIGS. 10A, 10B, and 10C are side, front, and rear elevation views respectively showing an illustrative control spout in an outward and rearward orientation.

FIGS. 11A, 11B, and 11C are side, front, and rear elevation views respectively showing an illustrative control spout in an outward and forward orientation.

FIGS. 12, 13, and 14 are plan views the grain cart of FIGS. 1 through 5 transferring harvested grain into an illustrative receiving container.

FIG. 15 is a partial perspective view of the grain cart of FIGS. 1 through 5 transferring harvested grain into an illustrative receiving container.

FIG. 16 is a simplified block diagram of an exemplary automated grain unloading system.

### DETAILED DESCRIPTION

Illustrative embodiments according to at least some aspects of the present disclosure are described and illustrated below and include devices, systems, and methods relating to transferring agricultural materials, such as grain, into containers, including transport containers. The present disclosure includes, among other things, an improved grain discharge spout for transferring harvested grain into transport containers, an automated control system, and related methods. Some illustrative embodiments according to at least some aspects of the present disclosure are described below in the context of a grain cart and operations involving transferring grain from the grain cart to another container. It will be appreciated that similar devices, systems, and methods may be utilized in connection with other agricultural equipment and containers. As used herein, “transport container” may refer to any device configured to hold harvested grain during movement from one location to another location. Exemplary transport containers may include various types of agricultural equipment, such as grain carts, gravity wagons, grain tanks, grain hopper trailers for tractor-trailers, and the like. Transport containers may also include railcars configured to haul grain, barge or ship holds configured to haul grain, and the like. As used herein, “supplying container” may refer to a container from which grain is transferred and “receiving container” may refer to a container into which grain is transferred.

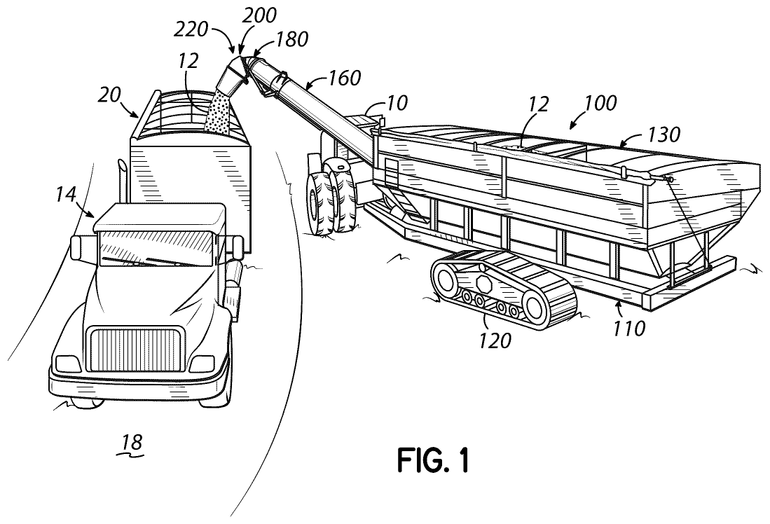

FIG. 1 is a perspective view of an illustrative grain cart 100, coupled to a tractor 10, transferring harvested grain 12 to a receiving container 20, such as a grain hopper trailer coupled to a semi-tractor 14 parked on a road 18 adjacent to a field, according to at least some aspects of the present disclosure.

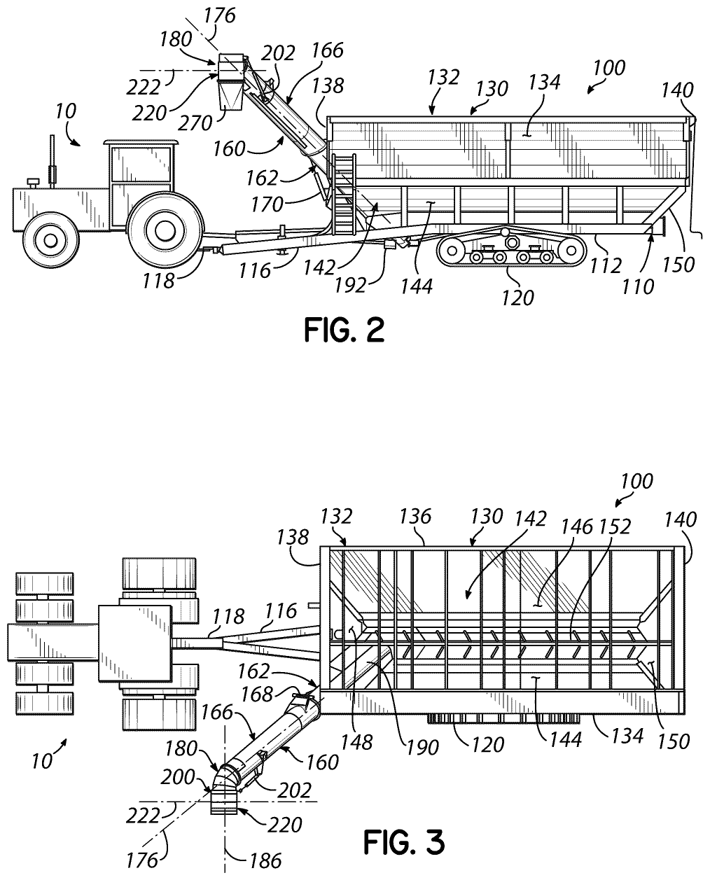

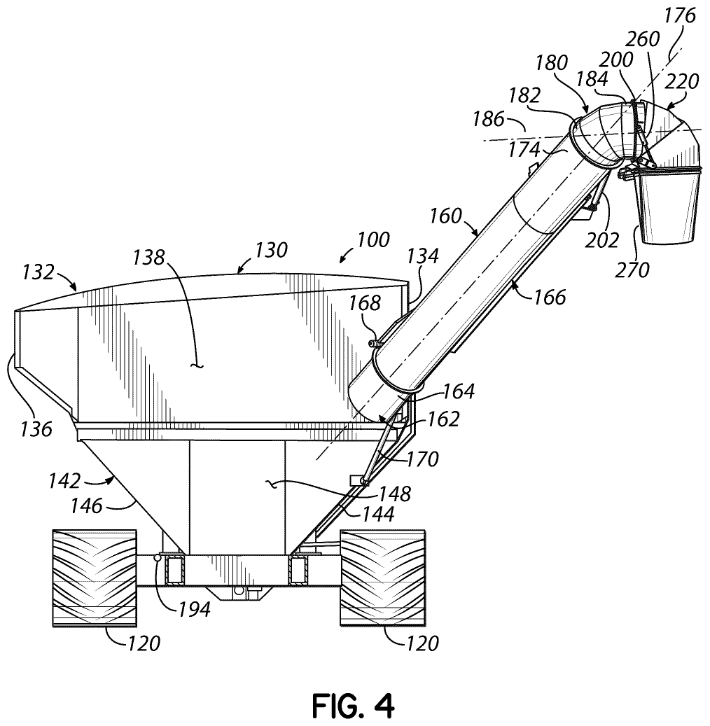

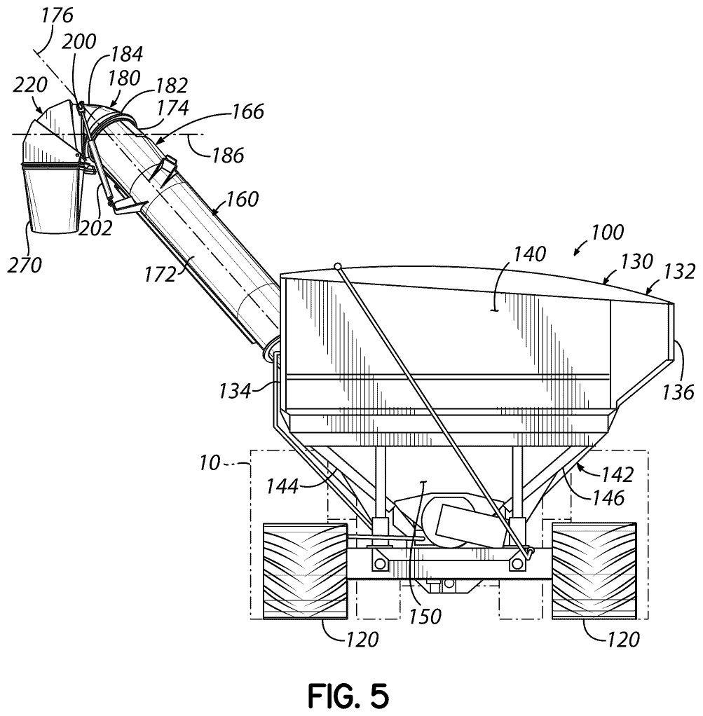

FIG. 2 is a side elevation view and FIG. 3 is a plan view of an illustrative grain cart 100 coupled to a tractor 10. FIGS. 4 and 5 are front and rear elevation views respectively of an illustrative grain cart 100, all according to at least some aspects of the present disclosure. The grain cart 100 includes a frame 110, a supplying container 130 for holding harvested grain or other agricultural material, and a grain transfer element 160.

Referring to FIGS. 1, 2, and 3, in this illustrative embodiment, the frame 110 includes longitudinally extending frame members 112 connected by frame cross members. The frame 110 is configured to support the supplying container 130. The frame members 112 converge at the front of the grain cart 100 to form a tongue 116 having a hitch 118 at the front of the grain cart 100. The hitch 118 is configured to be pivotally connected to a tow vehicle such as a tractor 10. The frame includes one or more pairs of wheels or tracks 120 supporting the frame 110 off the ground and configured for traversing the ground. When the grain cart 100 is connected to a tow vehicle, the wheels or tracks 120 allow the grain cart 100 to be moved to receive harvested grain from a combine in a field and then be moved to unload the grain into a receiving container 20, such as a grain hopper trailer parked on a road 18 adjacent to a field, for example, see FIG. 1.

The supplying container 130 is a grain hopper fabricated from sheet metal and supported by the frame 110. The supplying container 130 includes a generally rectangular upper portion 132. The upper portion 132 includes opposed upper left and right side walls 134, 136 connected by an upper front wall 138 and an upper rear wall 140. In this illustrative example, the upper left and right side walls 134, 136 are connected to the upper front and rear walls 138, 140 by square corners. In other embodiments, the upper left and right side walls 134, 136 may be connected to the upper front and rear walls 138, 140 by radiused or angled corners. The supplying container 130 also includes a sloped lower portion 142 including sloped lower left and right side walls 144, 146 connected by a sloped lower front wall 148 and a sloped lower rear wall 150. In some embodiments, the lower front and rear walls 148, 150 may be vertical. In this illustrative example, the lower left and right side walls 144, 146 are connected to the lower front and rear walls 148, 150 by square corners. In other embodiments, the lower left and right side walls 144, 146 may be connected to the lower front and rear walls 148, 150 by radiused or angled corners. The upper left and right side walls 134, 136 are respectively coupled to the lower left and right side walls 144, 146. The upper front and rear walls 138, 140 are respectively coupled to the lower front and rear walls 148, 150.

Referring to FIGS. 2 through 5, the sloped lower portion 142 guides agricultural material to the bottom of the supplying container 130 for transfer to a receiving container 20 via the grain transfer element 160. In this illustrative embodiment, the supplying container 130 includes a floor auger 152 in the bottom of the supplying container 130. The floor auger 152 is configured to move grain toward the grain transfer element 160. In some embodiments, the supplying container 130 may not have a floor auger 152.

In this illustrative embodiment, the grain transfer element 160 includes an inclined lift conveyor 162, discharge spout 180, swivel joint 200, and control spout 220. In this illustrative example, the lift conveyor 162 is an auger conveyor. In other embodiments, the lift conveyor 162 may be any device configured for unloading grain from a supplying container 130. The lift conveyor 162 includes a lower section 164, an upper section 166, a hinge 168, and a conveyor actuator 170. The lower section 164 of the lift conveyor 162 includes a cylindrical sheet metal lower auger housing enclosing a lower auger section having a helical flight welded to a lower auger shaft. The upper section 166 of the lift conveyor 162 includes a cylindrical sheet metal upper auger housing enclosing an upper auger section having a helical flight welded to an upper auger shaft. In this illustrative embodiment, the lift conveyor 162 has a central axis 176 aligned generally along the centerlines of the lower section 164 and the upper section 166 of the lift conveyor 162 when in an unloading position, see FIGS. 2, 3, and 4. In some embodiments, the central axis of the upper section 166 of the lift conveyor 162 may be at an angle to the central axis of the lower section 164. Aligning the upper section 166 of the lift conveyor 162 at an angle to the lower section 164 may extend the side and/or forward reach of the discharge spout 180 and control spout 220 without affecting the attachment of the lower section 164 to the container 130.

The upper section 166 of the lift conveyor 162 is movably coupled to the lower section 164 by the hinge 168, see FIG. 4. The hinge 168 allows the upper section 166 to move between one or more stored positions adjacent the upper and/or lower front walls 138, 148 of the supplying container 130 and an inclined unloading position. The conveyor actuator 170 is coupled to the lower section 164 and the upper section 166 of the lift conveyor 162. The upper section 166 is moved between its stored position and its unloading position by the conveyor actuator 170. The conveyor actuator 170 may be remotely controlled from the cab of the tractor 10. In this illustrative embodiment, the conveyor actuator 170 is a hydraulic cylinder. In other embodiments, the conveyor actuator 170 may be another type of actuator such as a linear actuator, for example. The conveyor actuator 170 may be hydraulicly actuated, electrically actuated, or actuated with a combination of electrical and hydraulic components, such as an electric-over-hydraulic valve bank, for example. Any other actuation systems may be used to facilitate these functions.

FIGS. 1 through 5 show the grain transfer element 160 in an unloading position. In the unloading position, the upper section 166 of the lift conveyor 162 projects generally upwardly from the bottom of the supplying container 130, generally forwardly of the upper front wall 138, and generally laterally outwardly from the left side wall 134 of the supplying container 130. In some embodiments, the upper section 166 may project generally forwardly of the upper front wall 138, and generally laterally outwardly from the right side wall 136 of the supplying container 130 when in the unloading position. By extending upwardly, laterally outwardly, and forwardly from the supplying container 130, the grain transfer element 160 may be conveniently viewed by the driver of the tractor 10 while unloading grain 12 from the grain cart 100.

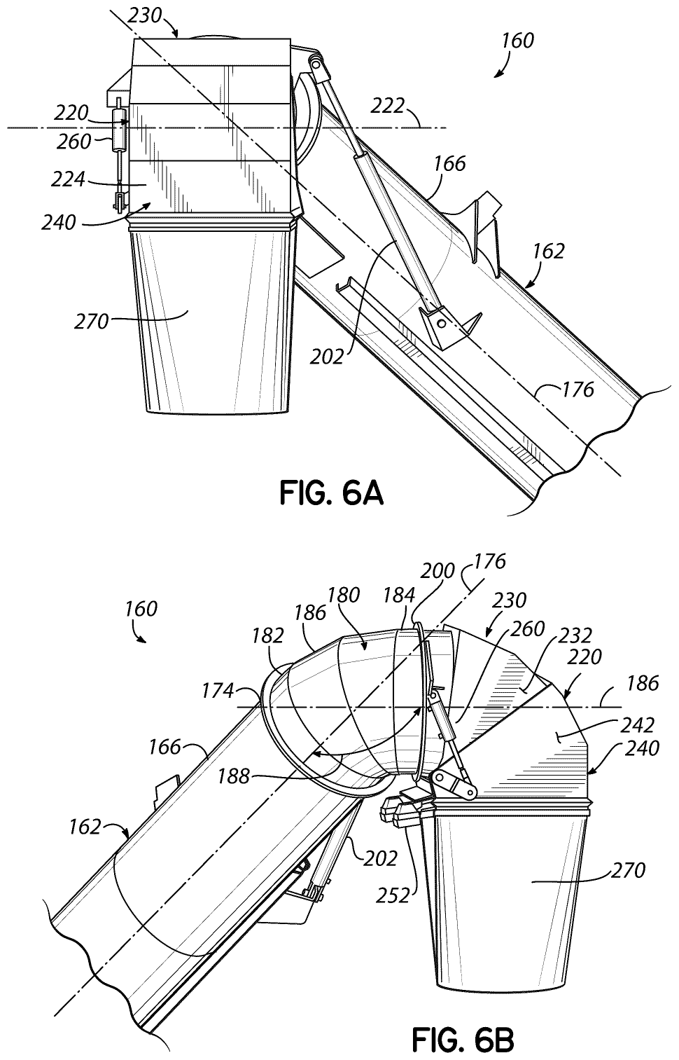

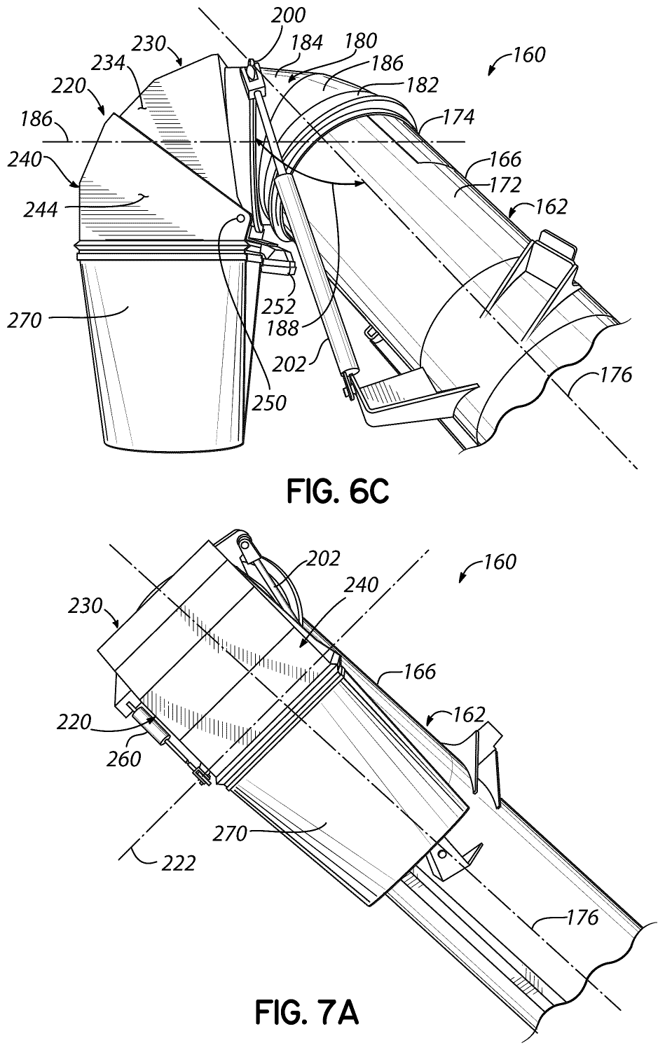

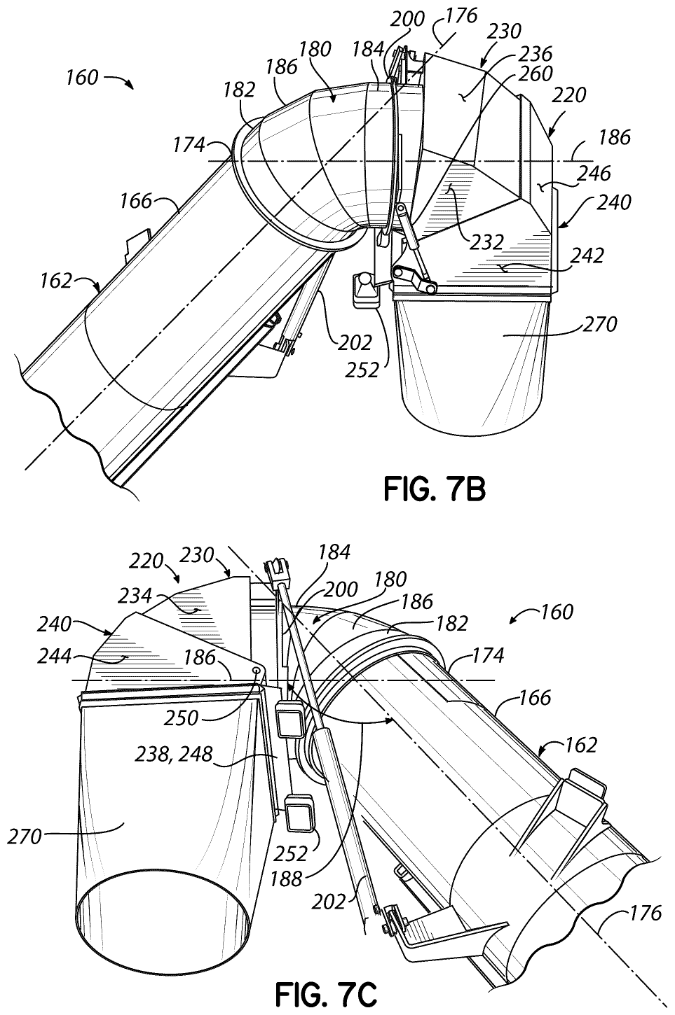

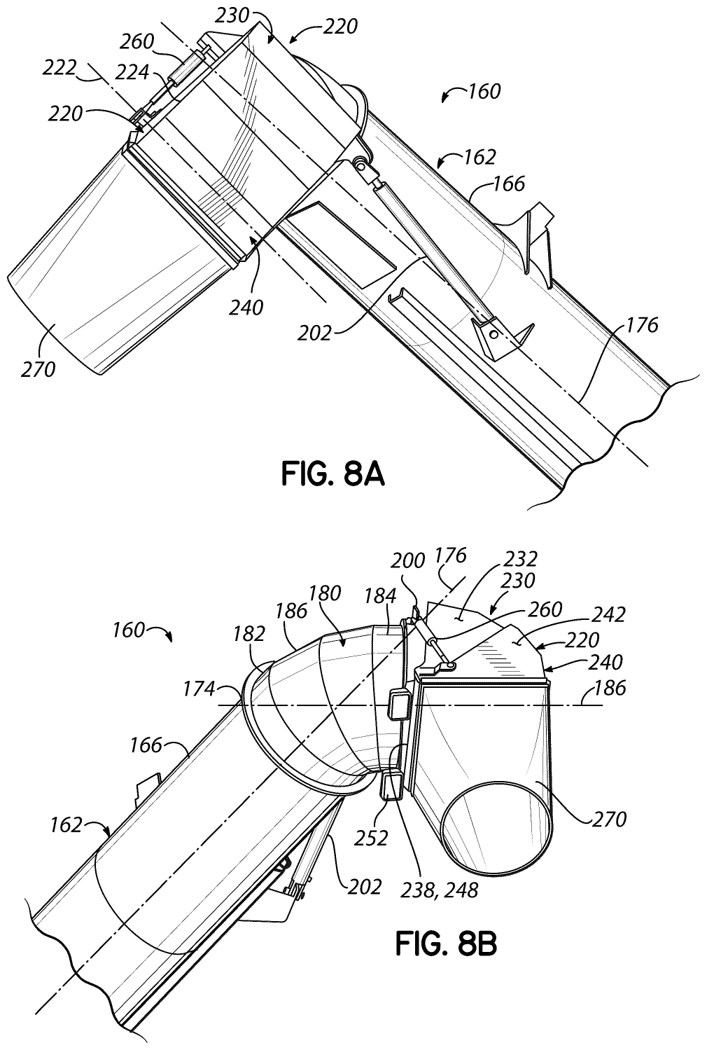

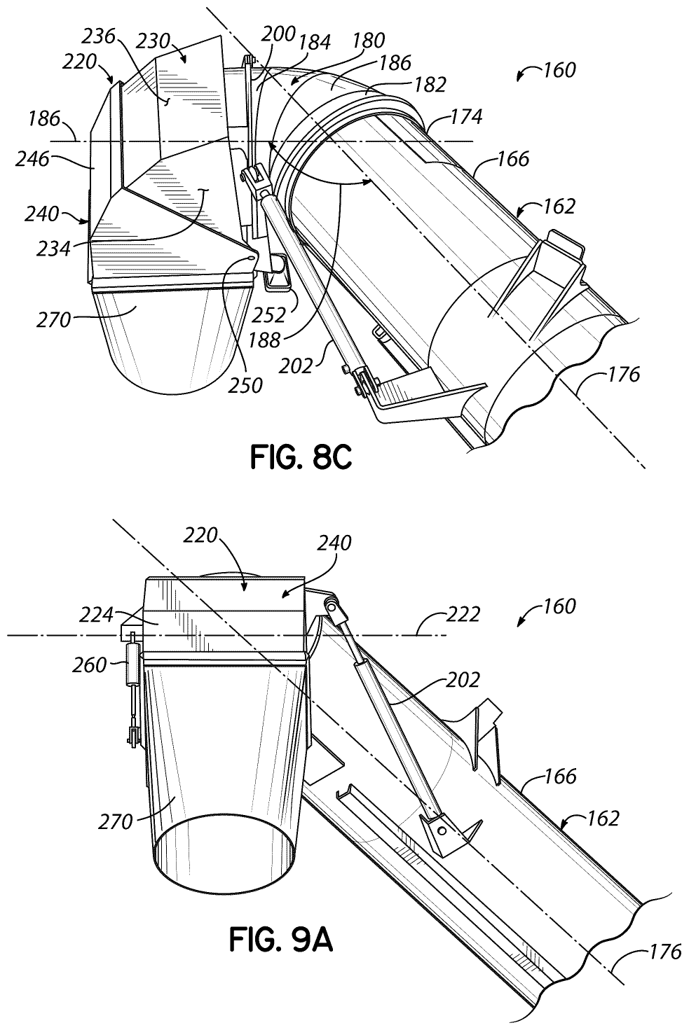

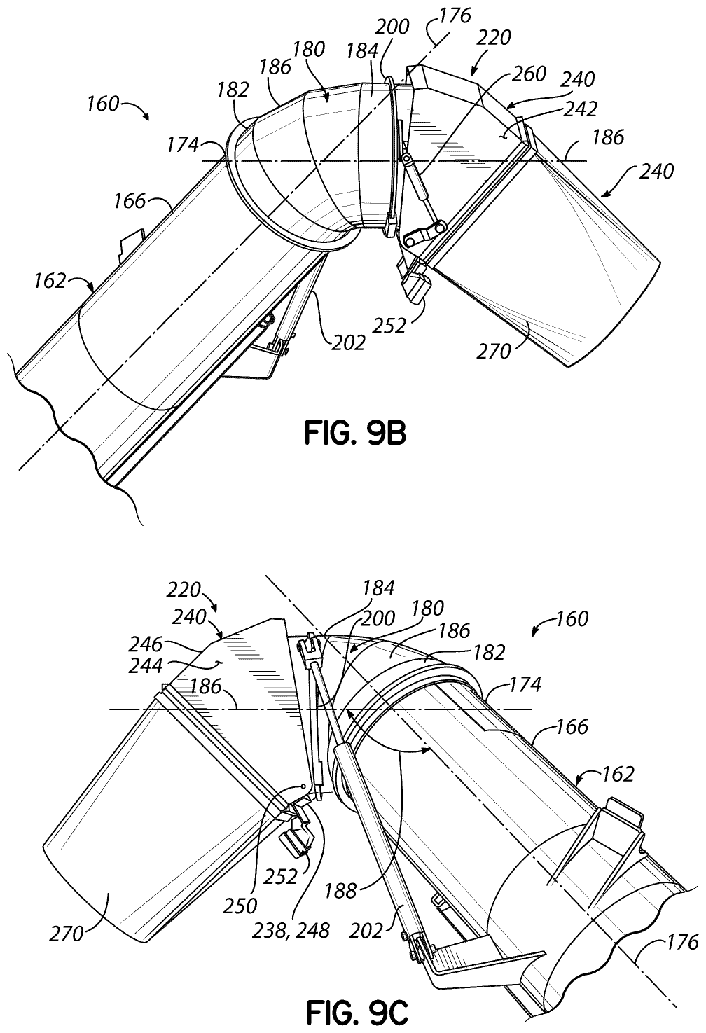

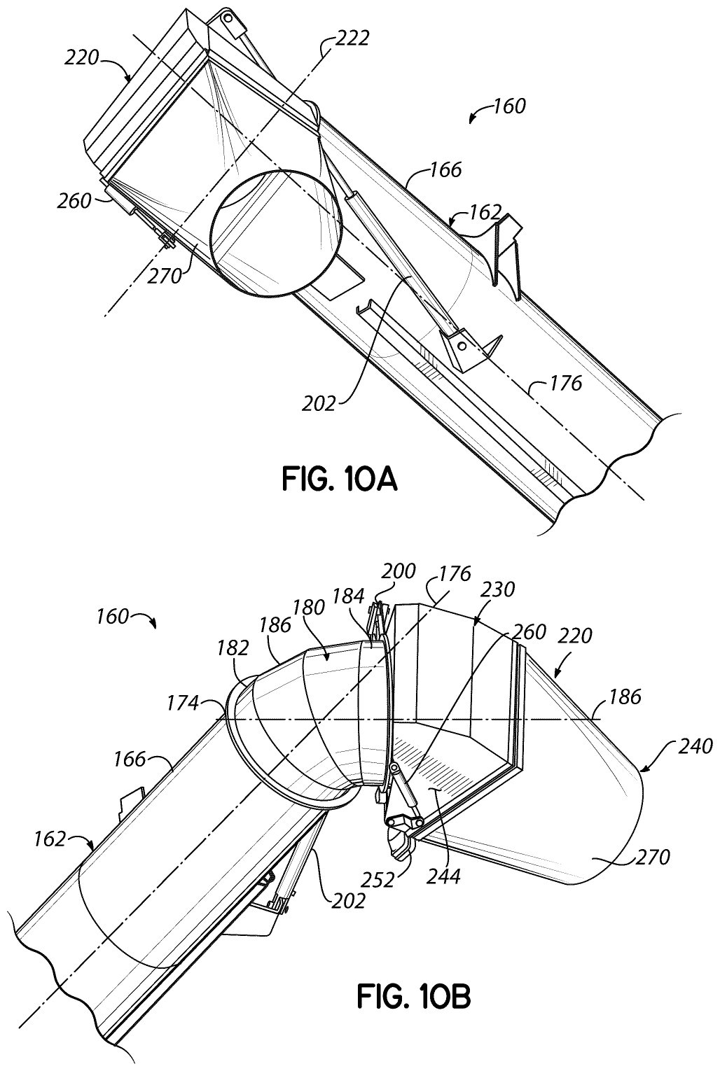

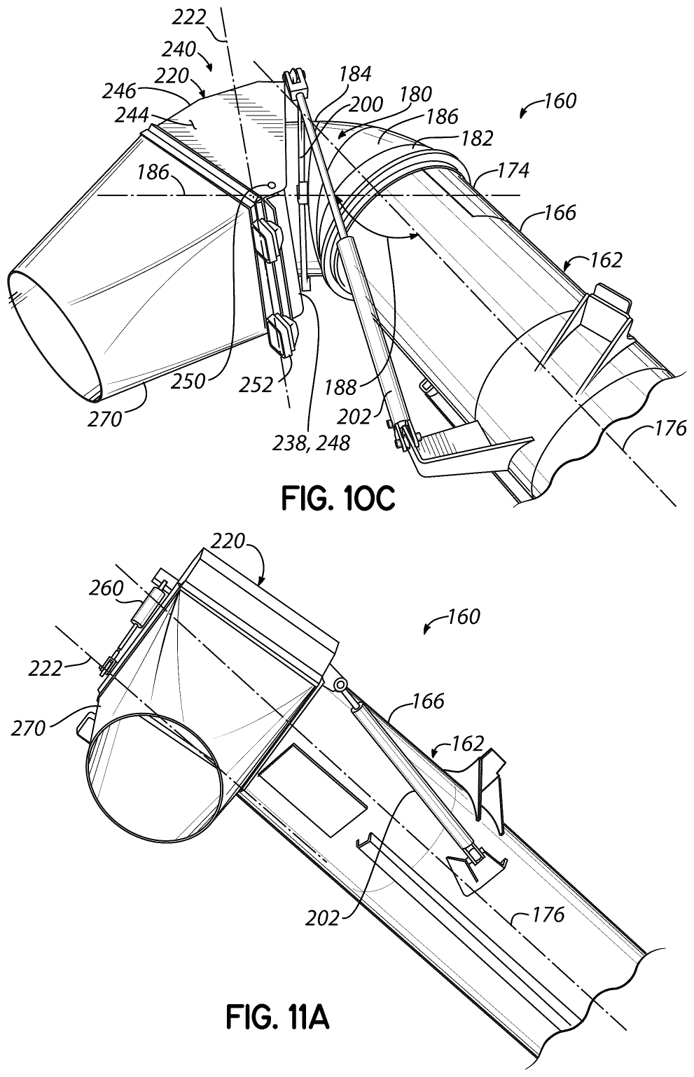

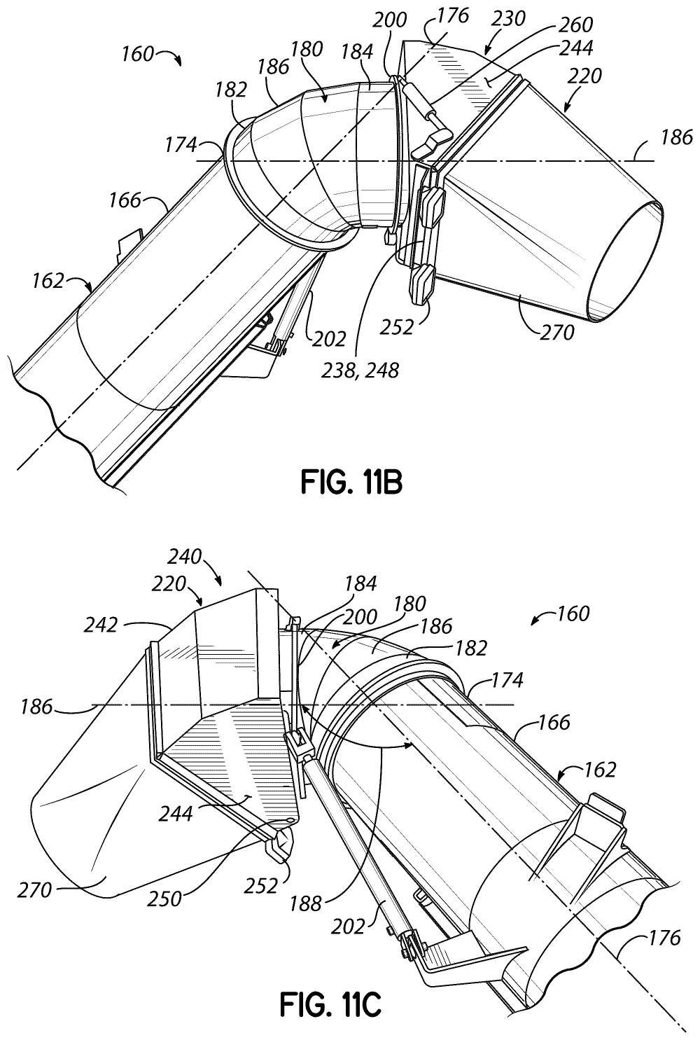

FIGS. 6A, 6B, and 6C are side, front, and rear elevation views respectively showing the control spout 220 in a downward and neutral orientation similar to the control spout 220 orientation shown in FIGS. 2 through 5. FIGS. 7A, 7B, and 7C are side, front, and rear elevation views respectively showing the control spout 220 in a downward and rearward orientation. FIGS. 8A, 8B, and 8C are side, front, and rear elevation views respectively showing the control spout 220 in a downward and forward orientation. FIGS. 9A, 9B, and 9C are side, front, and rear elevation views respectively showing the control spout 220 in an outward and neutral orientation. FIGS. 10A, 10B, and 10C are side, front, and rear elevation views respectively showing the control spout 220 in an outward and rearward orientation. FIGS. 11A, 11B, and 11C are side, front, and rear elevation views respectively showing the control spout 220 in an outward and forward orientation, all according to at least some aspects of the present disclosure.

Referring to FIGS. 6A, 6B, and 6C, in this illustrative embodiment, the discharge spout 180 is a tubular elbow with a generally round cross section. In some embodiments, the discharge spout 180 may have a generally rectangular cross section. In some embodiments, the discharge spout 180 may have a polygonal cross section. As disclosed herein, the construction, orientation, and operation of the discharge spout 180 is described with the grain transfer element 160 in an unloading position. The discharge spout 180 has an inlet 182 and an outlet 184. The inlet 182 of the discharge spout 180 is coupled to an outlet 174 of the upper section 166 of the lift conveyor 162. The discharge spout 180 has an outlet axis 186, or first axis, that is generally aligned with the centerline of the outlet 184 of the discharge spout 180. The outlet axis 186 is spaced forward of and is generally parallel to the upper front wall 138 of the supplying container 130. The outlet 184 of the discharge spout 180 projects laterally from the grain transfer element 160 as shown by the angle 188 between the outlet axis 186 and the central axis 176. In this illustrative embodiment, the outlet axis 186 is generally horizontal. In some embodiments, the outlet axis 186 may be oriented upwardly or downwardly from horizontal. The inside of the discharge spout 180 is radiused and configured to allow for the smooth transition of the flow of grain from the lift conveyor 162 through the swivel joint 200 and into the control spout 220. During a grain unloading operation, the discharge spout 180 must redirect the grain that is traveling in a direction illustrated by the central axis 176 of the lift conveyor 162 to a direction illustrated by the outlet axis 186 of the discharge spout 180.

In this illustrative embodiment, the swivel joint 200 is coupled to the outlet 184 of the discharge spout 180. As disclosed herein, the construction, orientation, and operation of the swivel joint 200 is described with the grain transfer element 160 in an unloading position. The swivel joint 200 has a generally round through opening. The swivel joint 200 is configured to allow grain to flow from the discharge spout 180 through the swivel joint 200 and to the control spout 220. In this illustrative embodiment, the swivel joint actuator 202 is coupled to the swivel joint 200 and the upper section 166 of the lift conveyor 162. In other embodiments, the swivel joint actuator 202 may be connected to the swivel joint 200, the lift conveyor 162, the discharge spout 180, and/or the control spout 220. The swivel joint actuator 202 is configured to rotatably move the swivel joint 200 to rotatably move the control spout 220 about the outlet axis 186 of the discharge spout 180. The control spout 220 can be moved between a forwardly projecting orientation (see FIGS. 8A, 8B, 8C, 11A, 11B, and 11C), a neutral orientation (see FIGS. 2 through 5, 6A, 6B, 6C, 9A, 9B, and 9C), and a rearwardly projecting orientation (see FIGS. 7A, 7B, 7C, 10A, 10B, and 10C), by the swivel joint actuator 202. The swivel joint 200 and swivel joint actuator 202 are configured to allow for 45° of movement forward and backward from vertical. Other embodiments may allow for more or less movement forward and backward from vertical. The swivel joint actuator 202 may be remotely controlled from the cab of the tractor 10. In this illustrative embodiment, the swivel joint actuator 202 is a hydraulic cylinder. In other embodiments, the swivel joint actuator 202 may be another type of actuator such as a linear actuator, hydraulic motor, or electric motor, for example. The swivel joint actuator 202 may be hydraulicly actuated, electrically actuated, or actuated with a combination of electrical and hydraulic components, such as an electric-over-hydraulic valve bank, for example, or any other actuation system.

Referring again to FIGS. 6A, 6B, and 6C, in this exemplary embodiment, the control spout 220 includes an inlet section 230, an outlet section 240, hinge pins 250, one or more lights 252, a control spout actuator 260, and an outlet nozzle 270. As disclosed herein, the construction, orientation, and operation of the control spout 220 is described with the grain transfer element 160 in an unloading position.

The inlet section 230 of the control spout 220 is coupled to the swivel joint 200. The inlet section 230 of the control spout 220 has side walls 232, 234, a top portion 236, and a bottom portion 238. In this illustrative embodiment, the control spout 220 has a generally rectangular cross section. In some embodiments, the control spout 220 may have a generally round cross section. In other embodiments, the control spout 220 may have a polygonal cross section. The outlet section 240 of the control spout 220 has side walls 242, 244, a top portion 246, and a bottom portion 248. The side walls 242, 244 of the outlet section 240 are parallel to the side walls 232, 234 of the inlet section 230. The side walls 242, 244 of the outlet section 240 of the control spout 220 are movably coupled to the side walls 232, 234 of the inlet section 230 by one or more hinge pins 250. The hinge pins 250 allow for pivotal movement of the outlet section 240 about the control spout axis 222, or second axis. The control spout axis 222 is at least partly defined by and aligned with the centerlines of the hinge pins 250. The control spout axis 222 rotates around the outlet axis 186 as the control spout 220 is rotated by the swivel joint 200 and swivel joint actuator 202, see FIGS. 6A, 7A, 8A, 9A, 10A, and 11A.

The outlet section 240 of the control spout 220 is configured for tilting movement about the control spout axis 222. The control spout axis 222 is generally parallel to the upper side walls 134, 136 of the supplying container 130. The control spout axis 222 is at an angle to the lift conveyor 162. The outlet section 240 is configured to move between a generally downwardly projecting discharge direction (see FIGS. 2 through 5, 6A, 6B, 60, 7A, 7B, 7C, 8A, 8B, and 8C) and a laterally outwardly projecting discharge direction (FIGS. 9A, 9B, 9C, 10A, 10B, 10C, 11A, 11B, and 11C). In some embodiments, the outlet section 240 may be directed in a generally laterally inwardly projecting discharge direction where the outlet section 240 is generally directed back toward the supplying container 130. The outlet section 240 is configured to move between 0° (straight down) to 55° outward. In some embodiments, the outlet section 240 may be configured to move between 10° inward to 55° outward. Other embodiments may allow for more or less movement inward and outward.

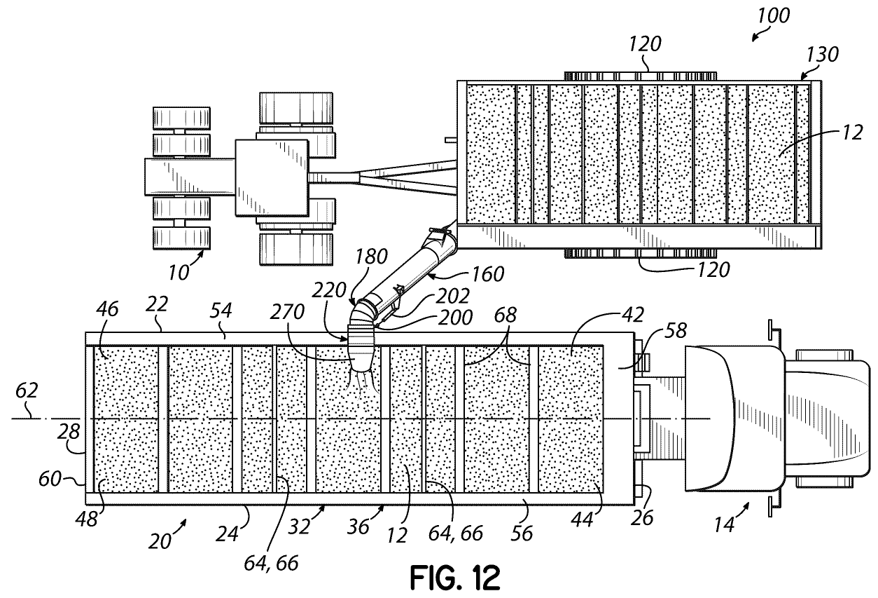

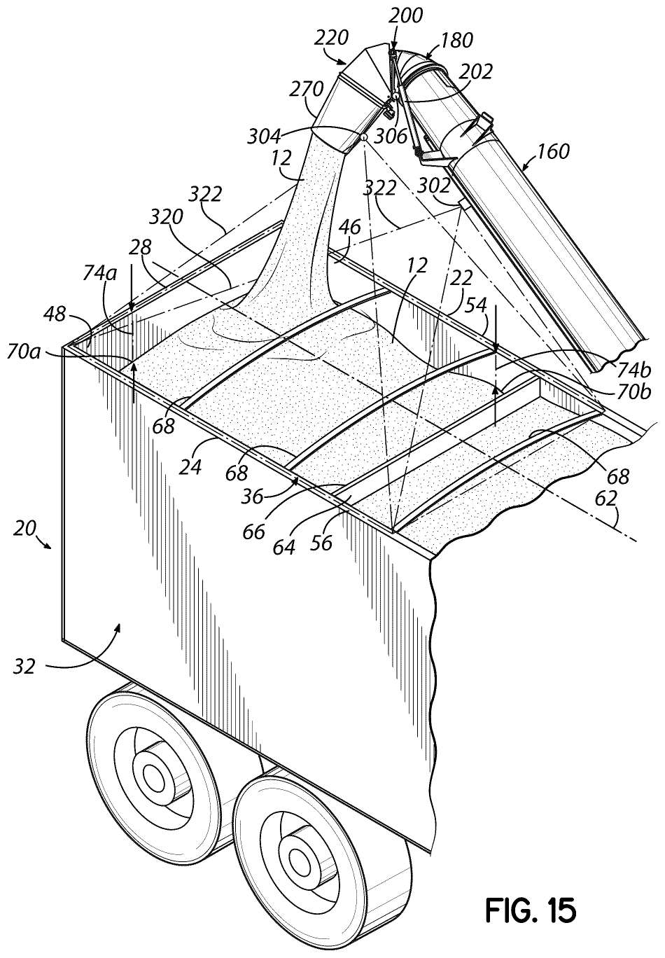

FIGS. 12, 13, and 14 are plan views and FIG. 15 is a partial perspective view of the illustrative grain cart 100 transferring the harvested grain 12 into an illustrative receiving container 20, according to at least some aspects of the present disclosure. The described alignment of the outlet axis 186 and the control spout axis 222 improves the alignment and orientation of the control spout 220 to a receiving container 20.

Referring to FIGS. 2 and 3, the controls for directing the control spout 220 will most often be aligned with the outlet axis 186 and the control spout axis 222 and be more intuitive for the operator. The improved alignment and orientation of the control spout 220 allows an operator to control the orientation of control spout 220 more easily during a grain unloading operation, for example, see FIGS. 12, 13, and 14. This improved alignment and orientation of the control spout 220 also decreases the risk of the operator directing the control spout 220 in an unintended direction. This improved alignment and orientation of the control spout 220 also simplifies the programing of automated control systems described herein.

In some embodiments, the bottom portion 248 of the outlet section 240 may be movably coupled to the bottom portion 238 of the inlet section 230 of the control spout 220 with a hinge, such as a piano hinge, for example. In this illustrative embodiment, the control spout actuator 260 is coupled to the inlet section 230 and the outlet section 240 of the control spout 220. The control spout actuator 260 is configured to move the outlet section 240 of the control spout 220 about the control spout axis 222 between a generally downwardly projecting orientation, (see FIGS. 2 through 5, 6A, 6B, 6C, 7A, 7B, 7C, 8A, 8B, and 8C), and a laterally outwardly projecting orientation, (see FIGS. 9A, 9B, 9C, 10A, 10B, 10C, 11A, 11B, and 11C). In some embodiments, the control spout actuator 260 may be configured to move the outlet section 240 in a generally laterally inwardly projecting discharge direction where the outlet section 240 is generally directed back toward the supplying container 130. The control spout actuator 260 may be remotely controlled from the cab of the tractor 10. In this illustrative embodiment, the control spout actuator 260 is a hydraulic cylinder. In some embodiments, the control spout actuator 260 may be another type of actuator such as a linear actuator, hydraulic motor, or electric motor, for example for example. The control spout actuator 260 may be hydraulicly actuated, electrically actuated, or actuated with a combination of electrical and hydraulic components, such as an electric-over-hydraulic valve bank, for example, or any other actuation system.

Referring to FIG. 12, for illustrative purposes, the receiving container 20 is described herein as a grain hopper trailer. The receiving container 20 may be any container configured for receiving grain. In this illustrative example, the receiving container 20 includes left and right side walls 22, 24 connected by a front wall 26 and a rear wall 28. In this illustrative example, the receiving container 20 has a generally rectangular upper perimeter 36. The left and right side walls 22, 24 have upper edges 54, 56 respectively. The front and rear walls 26, 28 have upper edges 58, 60 respectively. The upper edges 54, 56, 58, 60 form the generally rectangular upper perimeter 36. The left and right side walls 22, 24 are connected to the front and rear walls 26, 28 by square corners. The left side wall 22 is connected to the front wall 26 by left front corner 42. The right side wall 24 is connected to the front wall 26 by right front corner 44. The left side wall 22 is connected to the rear wall 28 by left rear corner 46. The right side wall 24 is connected to the rear wall 28 by right rear corner 48. The receiving container 20 also includes a centerline 62 running longitudinally front to rear of the receiving container 20.

Some receiving containers 20 may include partitions 64 having an upper edge 66 that divide the receiving container 20 into compartments. Some receiving containers 20 may include cross members 68 (e.g., a lateral brace or a tarp bow).

Exemplary methods of operating a control spout 220 according to at least some aspects of the present disclosure are described below with reference to FIGS. 2, 12, 13, and 14, and may include optional and/or alternative structures and/or operations. Generally, unless specifically indicated otherwise, at least some of the various operations described herein may be performed or directed by a control system.

Referring again to FIG. 2, an exemplary grain cart 100 may be prepared for use, such as by coupling the grain cart 100 to a tractor 10. The grain cart's 100 power take-off shaft may be coupled to the tractor's power takeoff. Hydraulic lines may be connected between the tractor 10 and the grain cart 100. When in use, the grain cart 100 may be filled with grain 12 in a field while following alongside a harvester or combine which transfers the grain from the harvester to the grain cart 100. After the supplying container 130 of the grain cart 100 is filled with grain 12, the grain cart 100 is towed by the tractor 10 usually to the edge of the field and alongside a rectangular open top receiving container 20, such as a grain hopper trailer coupled to a semi-tractor 14. The tractor's hydraulics, or other source of energy for the grain cart are started and/or energized. If necessary, the grain transfer element 160 of the grain cart 100 is extended from a folded position to an unloading position.

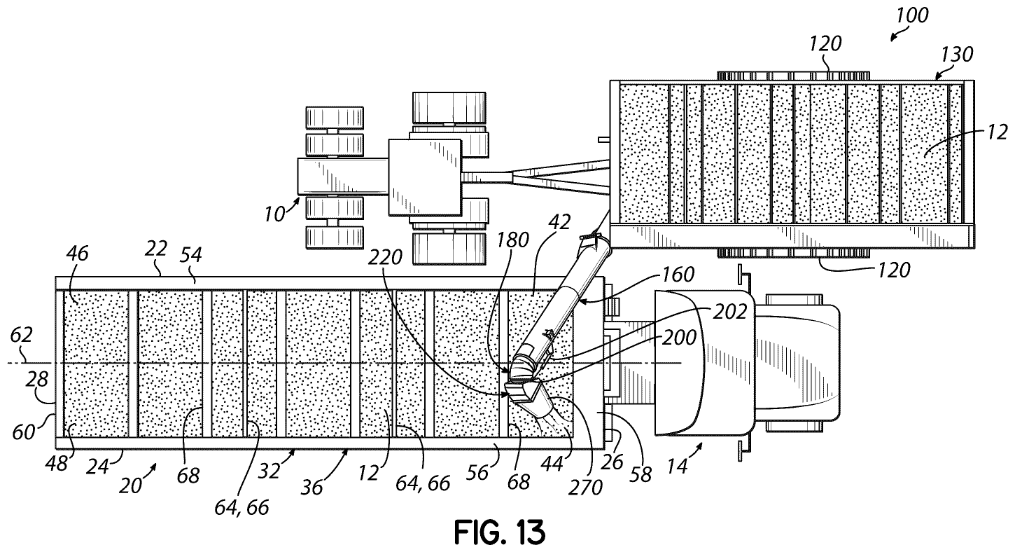

After the upper section 166 of the lift conveyor 162 is moved to its extended unloading position, the control spout 220 is positioned adjacent one end of the receiving container 20, see FIG. 13. The tractor's power takeoff or other source of energy (hydraulics) for the grain cart are started and/or energized. The operator starts unloading grain 12 from the grain cart 100 to the receiving container 20. While unloading grain 12, the grain cart 100 is pulled forwardly by the tractor 10 so that the receiving container 20 is progressively filled and topped off with grain 12. In some instances, the operator may move the grain cart 100 in a rearward direction with the tractor 10 while unloading grain 12.

Referring to FIGS. 12, 13, and 14, during unloading, and while the grain cart 100 travels the length of the receiving container 20, the control spout 220 is pivoted back and forth between its downwardly projecting discharge direction (see FIGS. 6A, 6B, and 6C) and its laterally outwardly projecting discharge direction (see FIGS. 9A, 9B, and 9C) so that grain 12 is discharged between the left and right side walls 22, 24 of the receiving container 20.

While the grain cart 100 travels the length of the receiving container 20, the control spout 220 is pivoted back and forth between its downwardly projecting discharge direction (see FIGS. 6A, 6B, 6C, 9A, 9B, and 9C), its rearwardly projecting discharge direction (see FIGS. 7A, 7B, 7C, 10A, 10B, and 10C), and its forwardly projecting discharge direction (see FIGS. 8A, 8B, 80, 11A, 11B, and 11C). The operator will view the filling and topping off of the receiving container 20 from the cab of the tractor 10 to insure that the entire receiving container 20 is completely filled with grain 12. The grain cart 100 travels the length of the receiving container 20 while discharging grain 12 so that the grain 12 fills and tops off all portions of the receiving container 20. The operator may start filling the front portion of the receiving container 20, including both front corners 42, 44, before moving toward the rear of the receiving container 20, for example. The operator may finish filling the receiving container 20 by filling the rear of the receiving container 20, including both rear corners 46, 48, for example. The operator may direct the movement of the grain cart 100 relative to the receiving container 20 while also directing the control spout 220.

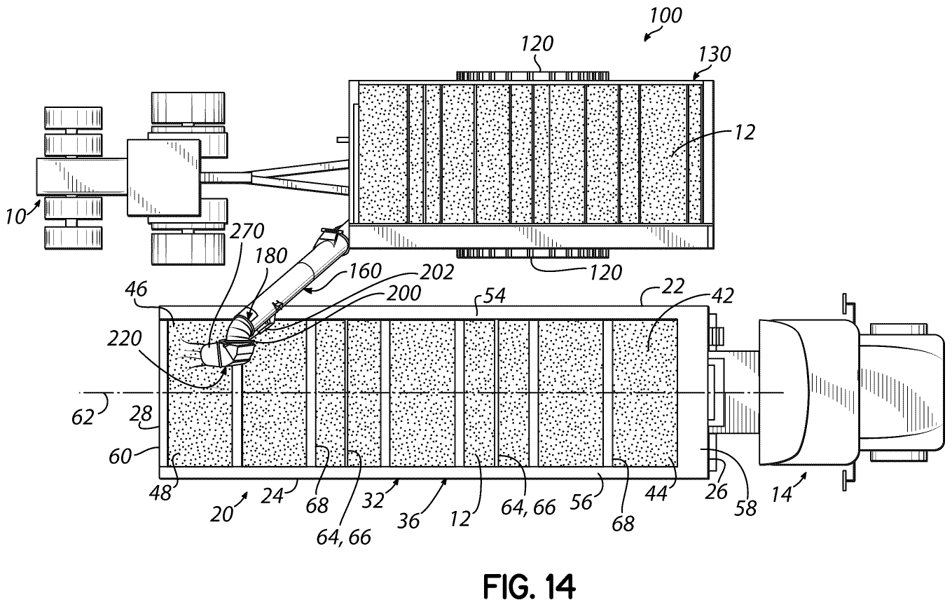

For illustration purposes, FIG. 12 shows the control spout 220 in its downwardly projecting discharge direction (see FIGS. 6A, 6B, and 6C) while filling the receiving container 20 with grain 12. In FIG. 13 the control spout 220 is shown in its laterally outwardly and rearwardly projecting discharge direction (see FIGS. 11A, 11B, and 11C) where the grain 12 is directed to fill the right front corner 44 of the receiving container 20. FIG. 14 shows the control spout 220 in its downwardly and forwardly projecting discharge direction (see FIGS. 8A, 8B, and 8C) where the grain 12 is directed to fill the left rear corner 46 of the receiving container 20. Moving the control spout 220 between the generally downwardly projecting discharge direction and the laterally outwardly projecting discharge direction and/or rotatably moving the control spout 220 between the forwardly projecting discharge direction and the rearwardly projecting discharge direction allows for uniform filling and topping off the rectangular receiving container 20 with grain including all four corners 42, 44, 46, 48.

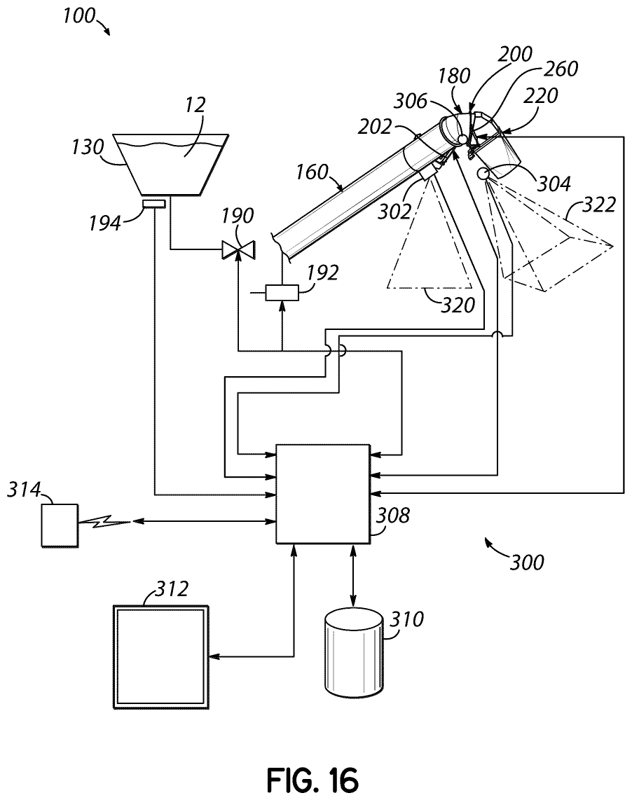

FIG. 16 is a simplified block diagram of an exemplary automated grain unloading system 300, according to at least some aspects of the present disclosure. In some embodiments, the grain cart 100 may include an automated grain unloading system 300. The system 300 is configured to operate during a grain unloading operation. Generally, the system 300 is configured to facilitate the transfer of the grain 12 from a suppling container 130, such as a grain cart 100, to a receiving container 20, such as a grain hopper trailer. The system is configured to reduce the likelihood of spilling grain 12 and/or facilitate increased grain transfer speed and/or efficiency.

Referring to FIGS. 15 and 16, in this illustrative embodiment, the automated grain unloading system 300 includes sensors 302, 304, a position sensor 306, a processor 308, a data storage device 310, a user interface 312, and a wireless user interface 314.

The system 300 includes one or more sensors 302, 304 configured to detect at least a portion of the receiving container 20 and/or contents of the receiving container 20, such as grain 12, for example. In some embodiments, at least one of the sensors 302, 304 may be configured to detect the orientation of the grain transfer element 160. In some embodiments, separate sensors 302, 304 may be utilized to detect at least a portion of the receiving container 20 and at least a portion of the contents of the receiving container 20. Similarly, multiple sensors 302, 304 having different fields of view 320, 322 (overlapping or not overlapping) may be utilized. In this illustrative system 300, sensor 302 is mounted to the lift conveyor 162 and sensor 304 is mounted to the outlet nozzle 270. Sensor 302 points generally outward and downward from the grain transfer element 160, thus having a field of view 320 including at least a portion of the receiving container 20. More specifically, the field of view 320 includes at least a portion of the area into which the control spout 220 is configured to discharge the grain 12. Depending on the extent of the field of view 320, only a portion of the entire upper perimeter 36 of the receiving container 20 may be detectable by the sensor 302 at any particular time. In some embodiments, the sensor 302 may be configured with a broader field of view 320, such as to detect portions of the receiving container 20 substantially beyond the area into which the control spout 220 is arranged to discharge the grain 12. In this arrangement, the field of view 320 of sensor 302 is fixed relative to the grain transfer element 160 while the field of view 322 of sensor 304 moves along with the outlet nozzle 270 and the control spout 220. By moving the field of view 322 of sensor 304 with the control spout 220, the system 300 can detect additional portions of the receiving container 130 and/or its contents. The one or more sensors 302, 304 may be mounted anywhere on the grain cart 100, including any portion of the grain transfer element 160.

In the illustrative system 300, the sensors 302, 304 are imaging radar scanners configured to scan the desired fields of view 320, 322. In alternative embodiments, the sensors 302, 304 may include any combination of one or more, radar sensors, imaging radar sensors, LIDAR (“light detection and ranging” and/or “laser imaging, detection, and ranging”), stereoscopic cameras, proximity sensors, time-of-flight sensors, time-of-flight cameras, and/or global navigation satellite system (e.g., global positioning system (GPS)) receivers, for example, or other sensors.

The system 300 includes one or more position sensors 306 configured to detect the position of the grain transfer element 160. The position sensor 306 may detect the position of portions of the grain transfer element 160. The position sensor 306 may be configured to detect the position of the inclined lift conveyor 162, discharge spout 180, swivel joint 200, and/or control spout 220. The position sensor 306 may monitor the movement, actuation, extension, rotation, and/or position of the conveyor actuator 170, swivel joint actuator 222, and/or control spout actuator 260. In some embodiments, the conveyor actuator 170, swivel joint actuator 222, and/or control spout actuator 260 may provide position inputs to the system 300. In some embodiments, the position sensor 306 may include one or more of an internal smart (position sensing) cylinder, an external smart (position sensing) cylinder, a linear position transducer, a radial transducer, a proximity sensor, a tilt sensor, an inertial measurement unit, and/or similar device or devices. In some embodiments, the sensors 302, 304 may be configured to detect the position of the grain transfer element 160.

Referring to FIG. 16, the illustrative system 300 includes one or more processors 308 configured to provide computation, analysis, control, and/or monitoring functions associated with various elements of the system 300, as described herein. The processor 308 receives inputs from the sensors 302, 304 and position sensor 306. The sensors 302, 304 and position sensor 306 may receive inputs from the processor 308. The processor 308 may also receive inputs from or direct the operation of other components of the grain cart 100. The processor 308 and/or other portions of the system 300 may be configured to use a standard communication protocol, such as ISOBUS and/or CANBUS, for example.

Referring to FIGS. 2, 15, and 16, in some embodiments, the position sensor 206 may be configured to monitor the orientation of the control spout 220 when the upper section 166 of the lift conveyor 162 moves between the one or more stored positions and the inclined unloading position. Monitoring and controlling the orientation of the control spout 220 may avoid contacting the grain cart 100 with the control spout 220 while also maximizing the clearance between the control spout 220 and the tractor 10 (this clearance can be critical when the tractor 10 turns sharply). Controlling the orientation of the control spout 220 in the one or more stored positions may minimize the risk of damage to the sensors 302, 304 from debris while moving (stones and other debris from the road or field, or inclement weather). Controlling the orientation of the control spout 220 to maximize the clearance to the tractor 10 may allow for a shorter grain cart tongue 116 which improves the visibility of the grain transfer element 160 from the tractor cab.

Referring to FIG. 16, the processor 308 may be operatively coupled to one or more data storage devices 310, which may include instructions for the processor 308 (e.g., software or firmware) and/or which may store data associated with operation of the system 300. Generally, unless specifically indicated otherwise, any operation described herein as being performed by the system 300 may be performed by, at the direction of, and/or under the control of the processor 308.

The illustrative system 300 includes one or more user interface devices 312, 314 operatively connected to the processor 308. A user interface device 312 may be a dedicated device, such as a control panel, monitor, or other device configured to interface with the processor 308. A user interface device 314 may be a smart phone, tablet computer, or other device configured to directly and/or wirelessly interface with the processor 308, for example. The user interface device 312, 314 may be mounted in the tractor 10, for example. The user interface device 312, 314 may include a graphical user interface. Various user interface devices 312, 314 may be operatively connected to the processor 308 via wires and/or wirelessly. For example, an operator driving a tractor 10 pulling a grain cart 100 may utilize a user interface device 312, 314 located in the cab of the tractor 10 to operate the system 300 on the grain cart 100. The user interface device 312, 314 may include a program, software, and/or firmware, for example, configured to interface with the processor 308. As one of many other alternatives for allowing operator control and interface with the system 300, some or all of the necessary processing hardware and/or software may be contained in and/or accessible through one or more hand held devices such as a tablet computer, lap top computer, smart phone and the like. The software may include a mobile phone application, for example, and/or may be stored remotely, such as “in the cloud.”

Referring to FIGS. 15 and 16, sensors 302, 304 are configured to detect various parameters associated with transferring grain 12 from a supplying container 130 to a receiving container 20. Sensors 302, 304 are configured to detect at least a portion of the receiving container 20, including at least a portion of the upper perimeter 36. The sensors 302, 304 may detect and/or distinguish one or more of the upper edges 54, 56, 58, 60 that define the upper perimeter 36. Such detection may not be of the edge or edges themselves but of other receivers or detectable components fixed at the desired location or locations. The sensors 302, 304 are also configured to detect at least a portion of the upper surfaces 38a, 38b of the grain mounds 40a, 40b in the receiving container 20. The sensors 302, 304 send inputs to the processor 308. The processor 308 compares the detected portion of the upper perimeter 36 and the detected portion of the upper surfaces 38a, 38b. Based at least in part on the result of the comparison of the detected portion of the upper perimeter 36 and the detected portion of the upper surfaces 38a, 38b, the processor 308 directs the operation of the grain transfer element 160. Operation of the grain transfer element 160 may include operation of the lift conveyor 162, discharge spout 180, swivel joint 200, and/or control spout 220.

In some embodiments, the sensors 302, 304 may be configured to detect material differences between the grain 12 and the receiving container 20. Some sensors can detect the different properties of different materials. For example, the sensors 302, 304 may be radar or imaging radar configured to detect different properties of the grain 12 and the material of construction of the receiving container 20.

In this illustrative embodiment, the position sensor 306 detects the position of the grain transfer element 160 and/or the position of the inclined lift conveyor 162, discharge spout 180, swivel joint 200, and/or control spout 220. The position sensor 306 sends inputs to the processor 308. The processor 308 compares the detected position of the grain transfer element 160 and/or the position of the inclined lift conveyor 162, discharge spout 180, swivel joint 200, and/or control spout 220 to other inputs to the processor 308, such as the detected portion of the upper perimeter 36 and/or the detected portion of the upper surfaces 38a, 38b. Based at least in part on these comparisons, the processor 308 directs the operation of the grain transfer element 160.

Referring again to FIGS. 15 and 16, the system 300 may be configured to determine that a particular detected upper edge is the front or rear wall upper edge 58, 60 by determining that the longitudinally extending left and/or right wall upper edges 54, 56 extend to, but not extend substantially beyond, the front or rear wall upper edge 58, 60. Similarly, a partition upper edge 66 or a cross member 68 (e.g., a lateral brace or a tarp bow) may be identified as an intermediate upper edge. The system 300 may determine the left and/or right wall upper edges 54, 48, for example, extend substantially beyond the partition upper edge 66 or a cross member 68. Generally, the system 300 may be configured to ignore intermediate upper edges that are within the upper perimeter 36. Alternatively, some embodiments of the system 300 may be configured to identify partitions 64 and/or may be configured to treat separate compartments of the receiving container 20 defined by partitions 64 as separate secondary receiving containers 20.

The sensors 302, 304 are also configured to detect the interfaces 70a, 70b between the grain mounds 40a, 40b and a wall 22, 24, 26, 28 and/or a partition 64 of the receiving container 20. The interfaces 70a, 70b may include a generally continuous, curved or straight line on the respective wall 22, 24, 26, 28 or a partition 64 of the receiving container 20. The processor 308 is configured to determine the freeboard 74a, 74b, which is used herein to refer to the vertical distance between a point on the interface 70a, 70b and a corresponding point on the upper edge 54, 56, 58, 60, 66. Some embodiments may determine the freeboard at multiple locations and/or on multiple walls 22, 24, 26, 28 and/or partitions 64 of the receiving container 20 simultaneously. For example, alternative embodiments may be configured to determine freeboard on opposite walls, on adjacent walls, on three of four walls, and/or on all walls of the receiving container 20. Some embodiments may be configured to determine freeboard on three walls and a partition defining a compartment of the receiving container 20. The processor 308 compares the freeboard 74a, 74b and other inputs to the processor 308, such as the detected position of the grain transfer element 160 and/or the position of the inclined lift conveyor 162, discharge spout 180, swivel joint 200, and/or control spout 220. The processor 308 may compare the freeboard 74a, 74b to a programmed minimum freeboard. Based at least in part on these comparisons, the processor 308 directs the operation of the grain transfer element 160.

In some embodiments, the processor 308 may be configured to determine a vertical distance between the upper surfaces 38a, 38b of the grain mounds 40a, 40b and a tarp bow 68. The system may be programed to ensure the upper surfaces 38a, 38b of the grain mounds 40a, 40b do not go above a tarp bow 68 during an unloading operation thereby ensuring that a tarp can be drawn over the receiving container 20.

In some embodiments comprising radar and/or laser-based sensors, the sensors 302, 304 may be configured to generate a point cloud of the fields of view 320, 322. The system 300 may be configured to detect and/or identify features of interest within the fields of view 320, 322 such as by assessing point density and/or performing analysis, such as a least squares fit. For example, the system 300 may be configured to identify at least a portion of the upper perimeter 36 of the receiving container 20 and at least a portion of the upper surfaces 38a, 38b of the grain mounds 40a, 40b in the receiving container 20.

In some embodiments, the sensors 302, 304 may be configured to obtain sufficient data for the system 300 to generate a three-dimensional map of at least a portion of the upper surfaces 38a, 38b of the grain mounds 40a, 40b. In some embodiments, the control system 300 may be configured to develop a three-dimensional map of substantially all of the upper surfaces 38a, 38b of the grain mounds 40a, 40b.

Referring to FIG. 15, in some circumstances, it may be advantageous to utilize a system 300 configured to detect one or more interfaces 70a, 70b between the grain mounds 40a, 40b and the receiving container 20 instead of a system configured to develop a three-dimensional map. For example, focusing on the interfaces rather than large areas of the surfaces 38a, 38b may require less scanning by the sensors 302, 304 (e.g., LIDAR scanner) and/or less processing. Additionally, substantial dust may be generated as the grain 12 is discharged into the receiving container 20, particularly where the incoming stream of grain 12 meets the upper surfaces 38a, 38b of the grain mounds 40a, 40b. As a result, in some circumstances, utilizing measurements at the wall of the receiving container (e.g., the mound-wall interface) may reduce scanning disruptions caused by dust.

Referring to FIGS. 15 and 16, in this illustrative example, the system 300 may direct the operation of the grain transfer element 160 and/or the lift conveyor 162, discharge spout 180, swivel joint 200, and/or control spout 220 to direct the grain 12 into the receiving container 20. Other automated component movements and/or grain transfer may be used as well. The system 300 may adjust the orientation of the control spout 220 to direct the grain 12 into portions of the receiving container 20 where there is less grain 12 to distribute the grain 12 more evenly in the receiving container 20, for example. Moving the control spout 220 between the downwardly projecting discharge direction and the laterally outwardly projecting discharge direction and/or rotatably moving the control spout 220 between the forwardly projecting discharge direction and the rearwardly projecting discharge direction allows for uniform filling and topping off the rectangular receiving container 20 with grain including the filling of all four corners 42, 44, 46, 48.

Generally, the illustrative system 300 is configured such that the receiving container 20 does not require special modifications, special markings visible to the sensor 302, etc., for proper operation of the system 300. For example, the system 300 is generally configured to detect some or all of the upper perimeter 36 of any receiving container 20, regardless of size, shape, color, orientation, etc. The system 300 is configured such that pre-programming with information about a particular receiving container 20 (e.g., container dimensions, capacity, etc.) is not required for operation of the system 300. Further, the system 300 does not require pre-programming of an unload process or processes to unload grain into a receiving container 20. The system 300 is generally configured to be substantially self-contained on or in association with the grain cart 100. For example, a user interface device 312, 314 may be operatively connected to the system 300 on the grain cart 100, even though the user interface device 312, 314 may not be physically located on the grain cart 100. The system 300 is capable of operating without communication between the system 300 and the receiving container 20. As such, the system 300 is generally configured to be capable of independent operation and for use with any receiving container 20.

The illustrative system 300 is configured to prevent excessive grain spillage. The system 300 evaluates the location of the upper perimeter 36 of the receiving container 20 relative to the position and/or orientation of the grain transfer element 160 and/or the control spout 220. For example, the system may determine that no receiving container 20 is present to receive the grain 12. In another example, the system may determine that the grain transfer element 160 and/or the control spout 220 is not properly positioned relative to the receiving container 20. In these instances, the system 300 may alert the operator to not begin an unloading operation. During an unloading operation, the system 300 may alert the operator to stop the unloading operation if grain spillage is likely. In some embodiments, the system 300 may prevent grain from being discharged from the grain transfer element 160 and/or the control spout 220. The system 300 may provide an indication to the operator that informs the operator of the reason or reasons the unloading operation was stopped. The system 300 may provide an indication to the operator that informs the operator that the unloading operation will be stopped if corrective action is not taken by the operator and/or system 300. The system 300 may provide the operator with recommended actions that would allow the system 300 to resume the unloading operation.

Referring to FIGS. 3 and 16, the grain cart 100 may include one or more grain transfer control elements 190, 192 configured to adjust the rate (including starting and/or stopping) of grain 12 transfer via the grain transfer element 160. For example, the grain cart 100 may include one or more repositionable gates 190 operatively interposing the supplying container 130 and the grain transfer element 160. Opening the gate 190 allows grain 12 to enter the grain transfer element 160 and shutting the gate 190 prevents grain 12 from reaching the grain transfer element 160. Positioning the gate 190 at an intermediate position between shut and open may allow the grain transfer element 160 to operate at less than its maximum grain transfer rate. The gate 190 may be hydraulically and/or electrically operable, for example. The system 300 may be configured to direct the operation of the one or more repositionable gates 190.

Referring to FIGS. 2 and 16, the grain cart 100 may include a selectively engageable mechanical element 192 in the drive train for the grain transfer element 160. For example, the selectively engageable mechanical element 192 may be a clutch which may be an electric and/or hydraulically operable device. The selectively engageable mechanical element 192 may be configured to selectively mechanically engage and disengage the grain transfer element 160, such as with respect to a power takeoff of a tractor 10 to which the grain cart 100 may be operatively coupled. In other embodiments including a hydraulically driven grain transfer element 160, the selectively engageable mechanical element 192 may comprise a remotely controllable valve configured to selectively operate the hydraulic motor from the source of hydraulic power. The system 300 may be configured to direct the operation of the selectively engageable mechanical element 192.

Referring to FIGS. 2, 3, 15, and 16, the illustrative system 300 is configured such that unloading is prevented unless the grain 12 is expected to be discharged into the receiving container 20 without substantial spillage. If the system 300 determines that grain 12 discharged from the grain transfer element 160 will not go into the receiving container 20 the system 300 may not open the gate 190. Similarly, the system 300 may include an auto-shutoff feature configured to shut the gate 190 and/or disengage the clutch 192 during unloading if the system 108 determines that the grain 12 will not go into the receiving container 20. For example, if the grain cart 100 or the receiving container 20 pulls away while grain transfer is in progress, the system 300 will shut the gate 190 and/or disengage the clutch 192 to prevent or minimize spillage. The system 300 may provide an indication to the operator that informs the operator of the reason or reasons the unloading operation was stopped. The system 300 may provide an indication to the operator that informs the operator that the unloading operation will be stopped if corrective action is not taken by the operator and/or system 300.

The grain cart may include one or more scale elements 194 (e.g., load cell or weigh bar) configured to detect the weight of the load in the supplying container 130 (e.g., the grain cart grain tank). For example, the scale element 194 may be configured to detect various weights of the grain cart 100 and/or supplying container 130, such as an empty weight, a loaded weight, and a current weight. The scale element communicates the weight of the grain cart 100 and/or supplying container 130 to the processor 308. By subtracting the appropriate measured weights, the weight of grain loaded and/or unloaded may be calculated. For example, by subtracting the empty weight from the current weight, an amount of grain 12 in the grain cart 100 may be determined. Then, by setting that current weight as the loaded weight and monitoring an updated current weight, an amount of grain 12 that has been unloaded may be determined. The system 300 may direct the transfer of grain 12 based at least in part on the weight of the grain 12 in at least one of the supplying container 130 and/or the receiving container 20. In some embodiments, a scale element 194 may be located on the receiving container 20 and may communicate a weight of the receiving container 20 to the processor 308. The scale element 194 may be configured to detect various weights of the receiving container 20, such as an empty weight, a loaded weight, and a current weight. In some embodiments, the scale element 194 may be configured to detect weights of separate compartments of the receiving container 20, such as compartments separated by partitions 64. The system 300 may be configured to direct the transfer of grain 12 based at least in part on the weight of the grain 12 in one or more compartments of the receiving container 20. The system 300 may be configured to fill the one or more compartments of the receiving container 20 to a loaded weight. In some embodiments, a scale element 194 located on the supplying container 130 may be used to communicate a weight of the grain 12 transferred into the one or more compartments of the receiving container 20 ensuring each compartment if filled to the desired loaded weight.

Exemplary methods of operating an automated grain unloading system 300 according to at least some aspects of the present disclosure are described below and may include optional and/or alternative structures and/or operations. Although the description focuses on the use of the automated grain unloading system 300 in connection with transferring grain from the grain cart 100 to a grain hopper trailer, it will be appreciated that generally similar operations may be utilized when transferring grain between other types of equipment, such as generally from any supplying container 130 to any receiving container 20. Generally, unless specifically indicated otherwise, the various operations described below may be automatically performed or directed by the processor 306, such as instructed by software or firmware.

Referring to FIG. 2, an exemplary grain cart 100 may be prepared for use, such as by coupling the grain cart 100 to a tractor 10. Additionally, the grain cart's 100 power takeoff connection may be coupled to the tractor's power takeoff. Additionally, hydraulic lines may be connected between the tractor 10 and the grain cart 100.

Referring to FIGS. 12 through 16, the grain cart 100 may be positioned near a receiving container 20 (e.g., a grain hopper trailer). The tractor's hydraulics, or other source of energy for the grain cart are started and/or energized. If necessary, the grain transfer element 160 of the grain cart 100 may be extended from a folded position. After the upper section 166 of the lift conveyor 162 is moved to its extended unloading position, the control spout 220 is positioned adjacent one end of the receiving container 20. The tractor's power takeoff or other source of energy (hydraulics) for the grain cart may be started and/or energized.

The system 300 activates sensors 302, 304 which attempt to detect portions of the receiving container 20. The system 300 may identify the near upper perimeter edge 54 and the far upper perimeter edge 56 and/or may confirm that both the near upper perimeter edge 54 and the far upper perimeter edge 56 are present within at least one of the fields of view 320, 322. If either the near upper perimeter edge 54 or the far upper perimeter edge 56 is not detected within the fields of view 320, 322 the system 300 may wait to proceed until they are both detected and/or the system 300 may alert the operator, such as via the user interface 310, 312. If either the near upper perimeter edge 54 or the far upper perimeter edge 56 is not detected, the system 300 may move the control spout 220 to move the field of view 322 of sensor 304 to detect portions of the receiving container 130 and/or its contents.

The system 300 may determine the location of a longitudinal centerline 62 of the receiving container 20, such as generally between the near upper perimeter edge 54 and the far upper perimeter edge 56. The system 300 may direct actuators 202, 260 to position the control spout 220 such that, when the grain 12 is discharged, the grain 12 will go into the receiving container 20 at a location approximately along the centerline 62. The system 300 may provide an indication to the operator to move the grain cart 100 relative to the receiving container 20 to allow the receiving container 20 to be more optimally filled. If the control spout 220 cannot be positioned so that discharged grain 12 will go into the receiving container 20 near the centerline 62, such as due to limitations on the extent of repositioning of the control spout 220 by the actuators 202, 260, the system 300 may wait to proceed until the grain cart 100 and/or the receiving container 20 is repositioned, and the operator may be notified. The system 300 may be configured to automatically reposition the control spout 220 as necessary during the grain transfer operation to maintain the discharge of grain 12 generally near the centerline 62, even if the grain cart 100 is moved relative to the receiving container 20 and/or if the control spout 220 is repositioned left or right (if capable). Thus, the system 300 may be configured to discharge the grain 12 generally at the centerline 62 even when the grain cart 100 and the receiving container 20 are not positioned precisely in parallel and/or are oriented somewhat transversely with respect to one another. As used herein, “transverse” may refer to relative angular orientations that are non-parallel (e.g., perpendicular or oblique).

Referring again to FIGS. 12 through 16, the system 300 may determine whether a left upper perimeter edge 58 and/or a right upper perimeter edge 60 are detected within the fields of view 320, 322. If a left upper perimeter edge 58 and/or a right upper perimeter edge 60 are detected, the system 300 may determine whether the current position of the control spout 220 will discharge grain 12 into the receiving container 20. The system 300 may position the control spout 220 to direct the stream of discharged grain 12 laterally farther away from the supplying container 130 and/or laterally nearer to the supplying container 130. The system 300 may position the control spout 220 to direct the stream of discharged grain 12 generally forwardly and/or generally rearwardly with respect to the supplying container 130.

The receiving container 20 may be divided into compartments separated by one or more partitions 64. The system 300 may detect at least a portion of a partition 64. The system 300 may direct the transfer of the grain 12 based at least in part on the detected portion of the partition 64. The receiving container 20 may include one or more cross members 68. The system 300 may direct the transfer of the grain 12 based at least in part on the detected portion of the cross member 68.

The control system 300 may direct the actuators 202, 260 to reposition the control spout 220 so as to direct the discharge stream of grain 12 into desired portions of the receiving container 20 including all four corners 42, 44, 46, 48. For example, in some circumstances, it may be desirable to fill a receiving container front portion first, then a rear portion, then a middle portion. If the control spout 220 cannot be repositioned to direct the discharged grain 12 into the receiving container 20, the system 300 may wait to proceed or pause the operation until the grain cart 100 and/or the receiving container 20 is repositioned, and the operator may be notified.

Once the system 300 has been directed to commence the grain transfer operation by the operator and the control spout 220 is positioned to discharge the grain 12 into the receiving container, the system 300 may begin unloading the grain cart 100 and discharge grain 12 into the receiving container 20. During the grain transfer operation, the sensor 302 may monitor the grain mound 40a, 40b and the upper perimeter 36 of the receiving container 20.

If, at any time during the grain transfer operation, the system 300 determines that the control spout 220 is positioned such that the grain 12 may be discharged outside of the receiving container 20, the system 300 may stop the transfer of grain 12. The system 300 may provide an indication to the operator that informs the operator of the reason or reasons the grain transfer was stopped. The system 300 may provide an indication to the operator that informs the operator that the grain transfer will be stopped if corrective action is not taken by the operator and/or system 300. Alternatively, if the system 300 determines the control spout 220 is repositionable to a position at which the grain 12 would be discharged into the receiving container 20, the system 300 may reposition the control spout 220.

Referring again to FIGS. 12 through 16, if, at any time during the grain transfer operation, the system 300 determines that the grain mound upper surface 38a, 38b has reached a volumetric fill limit, the system 300 may alert the operator to stop the transfer of grain 12. For example, the system 300 may monitor the freeboard 76a, 76b. If the detected freeboard 76a, 76b reaches a predetermined minimum limit (which may be set by the operator), the system 300 may alert the operator to stop the transfer of grain 12. Alternatively, if the system 300 determines the control spout 220 is repositionable to a position at which the grain 12 would be discharged into a portion of the receiving container 20 at which the freeboard 76a, 76b is above the minimum limit, the system 300 may reposition the control spout 220. The system 300 may continuously reposition the control spout 220 to evenly spread the grain 12 in the receiving container 20. The system 300 may alert the operator to reposition the grain cart 100 with respect to the receiving container 20 so that grain 12 would be discharged into a portion of the receiving container 20 at which the freeboard 76a, 76b is below the minimum limit. The system 300 may direct the transfer of grain 12 toward a portion of the receiving container 20 with a maximum freeboard. The system may alert the operator to move the grain cart 100 or stop the transfer of grain 12 to ensure the upper surfaces 38a, 38b of the grain mounds 40a, 40b do not go above a tarp bow 68. In some embodiments, the system 300 will automatically stop the transfer of grain 12, such as by closing the gates 190 and/or disconnecting the clutch 192.

In some embodiments, the system 300 may be configured to alert the operator to reposition the grain cart 100 with respect to the receiving container 20. For example, when filling a receiving container 20 such as a generally elongated grain-hopper trailer, for example, the operator may move the grain cart 100 with the tractor 10 generally along the side of the receiving container 20 to discharge grain 12 along most or all of the length of the receiving container 20. In some embodiments, the system 300 may be configured to stop and restart the flow of grain 12 automatically as the grain cart 100 is repositioned with respect to the receiving container 20. In some embodiments, the system 300 may predictively calculate the time until it can no longer unload into the receiving container 20 with the grain cart 100 at its current stationary position (will hit freeboard 76a, 76b or tarp bow 68 limit at all areas within reach of the control spout 220) and notify the operator how much time the operator has remaining until the system 300 slows or stops the unloading operation. The system 300 may suggest to the operator where to optimally reposition the grain cart 100 to allow continued unloading. It will be appreciated that, in some circumstances, similar operations may be conducted with the grain cart 100 remaining stationary and the receiving container 20 moving to allow various portions of the receiving container 20 to be filled.

In the illustrative system 300, the operator may set and/or adjust the freeboard minimum limit, such as by using the user interface 310, 312. The freeboard minimum limit may be specified as a vertical distance (e.g., using distance measurement units) and/or using a proportional numerical scale (e.g., 1-10). In some embodiments, the freeboard minimum limit may be determined by the operator specifying the type of grain 12 being transferred (e.g., rice-wet, rice-medium, or rice-dry) and/or the system 300 may determine an appropriate freeboard minimum limit based on the expected heap angle. Generally, the freeboard minimum limit may be set so that the risk of spillage during transport of the receiving container 20 is minimized, while also maximizing the use of the volume of the receiving container 20.

In the illustrative system 300, the operator may set a maximum unload weight limit. The system 300 may detect a weight of the grain 12 unloaded from the supplying container 130 and/or a weight of the grain 12 in the receiving container 20. The system 300 may stop the transfer of grain 12 upon determining that the weight of grain 12 unloaded has reached the maximum unload weight limit. In some embodiments, the receiving container 20 may be divided into compartments separated by one or more partitions 64. The operator may set a maximum weight limit of a compartment. The system 300 may detect a weight of the grain 12 unloaded into a compartment and stop and/or directing the transfer of grain 12 upon determining that the weight of grain 12 unloaded into the compartment has reached the weight limit of the compartment.

The system 300 may slow and/or or stop the transfer of grain 12, and providing a perceptible indication of the cause of the slowing and/or or stopping of the transfer of grain 12. The system 300 may provide a perceptible indication of actions to perform to resume the transfer of grain 12.

While the present invention has been illustrated by the description of specific embodiments thereof, and while the embodiments have been described in considerable detail, it is not intended to restrict or in any way limit the scope of the appended claims to such detail. For example, the illustrative grain cart described herein constitutes only one embodiment of the invention. It is to be understood that the invention is not limited to the precise form of the grain cart disclosed. The invention may be employed with other grain cart configurations without departing from the scope and spirit of the invention as defined in the appended claims. The various features discussed herein may be used alone or in any combination within and between the various embodiments. Additional advantages and modifications will readily appear to those skilled in the art. The invention in its broader aspects is therefore not limited to the specific details, representative apparatus and methods and illustrative examples shown and described. The illustrative embodiments as discussed may include optional steps, methods, and features that one of ordinary skill should recognize as not being a requisite to fall within the scope of the present disclosure.

What is claimed is:

1. A grain cart configured for transferring grain from the grain cart to a receiving container, the grain cart comprising:
a supplying container including a left side wall and a right side wall connected by a front wall and a rear wall and configured to receive grain; and
a grain transfer element, inclined upwardly, and forwardly from the front wall of the supplying container, and laterally outwardly from the left side wall or the right side wall of the supplying container, and configured to receive grain from the supplying container;
a control spout coupled to and projecting laterally outwardly from the grain transfer element, configured for movement around a generally horizontal first axis of rotation and a second axis of rotation generally parallel to the left side wall and the right side wall of the supplying container, and configured to direct the grain into the receiving container;
a first control spout actuator operatively coupled to the control spout and configured to move the control spout around the first axis of rotation between a forward discharge direction and a rearward discharge direction; and
a second control spout actuator operatively coupled to the control spout and configured to move the control spout around the second axis of rotation between a generally downward discharge direction and a laterally outward discharge direction;
wherein, moving the control spout between the forward discharge direction and the rearward discharge direction directs the discharged grain forwardly and rearwardly into the receiving container, and
wherein, moving the control spout between the generally downward discharge direction and the laterally outward discharge direction directs the discharged grain generally downwardly and laterally outwardly into the receiving container.

2. The grain cart of claim 1, further comprising a swivel joint rotatably coupling the control spout to the grain transfer element, the swivel joint configured to allow the rotation of the control spout around the first axis of rotation.

3. The grain cart of claim 2, wherein the first control spout actuator is coupled to at least one of the swivel joint or the control spout.

4. The grain cart of claim 2, wherein the second control spout actuator is coupled to at least one of the swivel joint or the control spout.

5. The grain cart of claim 1, wherein the control spout further comprises:
a control spout inlet section coupled to the grain transfer element; and
a control spout outlet section movably coupled to the control spout inlet section;
wherein the control spout outlet section moves between the generally downward discharge direction and the laterally outward discharge direction.

6. The grain cart of claim 5, wherein the second spout actuator is coupled to at least one of the control spout inlet section or the control spout outlet section.

7. The grain cart of claim 6, wherein the control spout inlet section includes at least one side wall supporting the control spout outlet section.

8. The grain cart of claim 7, wherein the control spout outlet section includes at least one side wall, and the at least one side wall of the control spout outlet section is coupled to the at least one side wall of the control spout inlet section.

9. The grain cart of claim 5, wherein the control spout inlet section includes a bottom portion,
wherein the control spout outlet section includes a bottom portion, and
wherein the bottom portion of the control spout outlet section is coupled to the bottom portion of the control spout inlet section.

10. The grain cart of claim 1, further comprising a discharge spout including a discharge spout outlet;
wherein the discharge spout is coupled to the grain transfer element,
wherein the control spout is coupled to the discharge spout outlet, and
wherein the discharge spout outlet projects laterally outwardly from the grain transfer element.

11. The grain cart of claim 1, further comprising an auger configured to move grain from the supplying container toward the grain transfer element.

12. The grain cart of claim 1, further comprising a control system for directing the movement of the control spout, the control system including a processor configured to direct the first control spout actuator to move the control spout between the forward discharge direction and the rearward discharge direction, and to direct the second control spout actuator to move the control spout between the generally downward discharge direction and the laterally outward discharge direction.

13. The grain cart of claim 12, wherein the control system further comprises a control spout position sensor configured to detect a position of the control spout and provide a signal to the processor;
wherein the processor directs the movement of the control spout based at least in part on the signal from the control spout position sensor.

14. The grain cart of claim 12, wherein the control system further comprises at least one receiving container sensor configured to detect at least a portion of an upper perimeter of the receiving container and at least a portion of an upper surface of a grain mound in the receiving container and provide a signal to the processor;
wherein the processor is configured to compare the detected portion of the upper perimeter and the detected portion of the upper surface, and the processor directs the movement of the control spout based at least in part on a result of the comparison of the detected portion of the upper perimeter and the detected portion of the upper surface.

15. The grain cart of claim 14, wherein the at least one receiving container sensor further comprises a first receiving container sensor configured to detect at least a portion of the upper perimeter of the receiving container and provide a signal to the processor and a second receiving container sensor configured to detect at least a portion of the upper surface of the grain mound in the receiving container and provide a signal to the processor.

16. The grain cart of claim 14, wherein based at least in part on a result of the comparison of the detected portion of the upper perimeter and the detected portion of the upper surface, the processor provides a perceptible indication to move at least one of the grain cart or the receiving container to position the control spout relative to the receiving container.

17. The grain cart of claim 14, wherein the at least one receiving container sensor comprises at least one of a LIDAR scanner, a radar sensor, an imaging radar sensor, a camera, a proximity sensor, a time-of-flight sensor, or a GPS receiver.

18. The grain cart of claim 14, wherein the at least one receiving container sensor is configured to detect material differences between the grain and the receiving container.

19. The grain cart of claim 14, wherein the processor is configured to prevent discharge of grain via the control spout if the processor determines that grain discharged from the control spout would not be discharged into the receiving container.

20. The grain cart of claim 14, wherein the processor is configured to evaluate the location of the upper perimeter of the receiving container relative to the position of the control spout.

21. The grain cart of claim 14, wherein the control system is configured to notify a user of at least one of a status, position, or operation of the control spout.

22. A method of operating a control spout configured to direct grain from a grain cart into a receiving container, the method comprising:
directing a first control spout actuator to move the control spout around a generally horizontal first axis of rotation between a forward discharge direction and a rearward discharge direction to direct the grain forwardly and rearwardly into the receiving container; and
directing a second control spout actuator to move the control spout around a second axis of rotation generally parallel to a left side wall and a right side wall of the grain cart between a generally downward discharge direction and a laterally outward discharge direction to direct the discharged grain generally downwardly and laterally outwardly into the receiving container.

23. The method of claim 22, further comprising:
detecting a position of the control spout; and
directing at least one of the first control spout actuator or the second control spout actuator based at least in part on the detected position of the control spout.

24. The method of claim 22, wherein the receiving container contains a grain mound, the method further comprising:
detecting at least a portion of an upper perimeter of the receiving container;
detecting at least a portion of an upper surface of the grain mound in the receiving container;
comparing the detected portion of the upper perimeter and the detected portion of the upper surface; and
directing at least one of the first control spout actuator or the second control spout actuator based at least in part on a result of the comparison of the detected portion of the upper perimeter and the detected portion of the upper surface.

25. The method of claim 22, further comprising:
detecting a position of at least one of the first control spout actuator or the second control spout actuator; and
directing at least one of the first control spout actuator or the second control spout actuator based at least in part on the detected position of at least one of the first control spout actuator or the second control spout actuator.

26. An automated grain unloading control system for a grain cart including a grain transfer element configured to transfer grain from the grain cart to a receiving container, the grain transfer element including a control spout configured to direct a stream of discharged grain, the control system comprising:
at least one first sensor configured to detect at least a portion of the receiving container and at least a portion of an upper surface of a grain mound in the receiving container;
at least one second sensor configured to detect at least one of an orientation of the grain transfer element or an orientation of the control spout; and
a processor configured to compare the detected portion of the receiving container, the detected portion of the upper surface, and at least one of the orientation of the grain transfer element or the orientation of the control spout, and control the operation of the grain transfer element to direct a transfer of grain from the grain cart to the receiving container and control the movement of the control spout around a generally horizontal first axis of rotation to direct the stream of discharged grain forwardly and rearwardly into the receiving container and control the movement of the control spout around a second axis of rotation generally parallel to a left side wall and a right side wall of the grain cart between a generally downward discharge direction and a laterally outward discharge direction based at least in part on a result of the comparison of the detected portion of the receiving container, the detected portion of the upper surface, and at least one of the orientation of the grain transfer element or the orientation of the control spout.

27. The control system of claim 26, wherein at least one the first sensor is configured to detect an interface of an upper surface of a grain mound in the receiving container and a wall of the receiving container, and at least a portion of an upper edge of the wall,
wherein the processor is configured to determine a plurality of freeboards by calculating a plurality of vertical distances between the detected interface and the detected portion of the upper edge of the wall, and
wherein the processor is configured to direct the transfer of grain based at least in part on the freeboards.

28. The control system of claim 26, wherein the processor determines a minimum freeboard by calculating a vertical distance between a highest point of the detected interface and a lowest point of the detected portion of the upper edge,
wherein the processor determines a maximum freeboard by calculating a vertical distance between a lowest point of the detected interface and a highest point of the detected portion of the upper edge, and
wherein the processor directs the transfer of grain toward a portion of the receiving container with the maximum freeboard.

29. The control system of claim 26, wherein the control spout is movable to direct the stream of discharged grain laterally farther away from the grain cart and laterally nearer to the grain cart.

30. The control system of claim 26, wherein the processor is configured to prevent a discharge of grain via the grain transfer element if the processor determines that the grain would not be discharged into the receiving container.

31. The control system of claim 26, wherein the processor is configured to provide a perceptible indication to move the grain cart to position the grain transfer element relative to the receiving container.

32. The control system of claim 26, wherein the processor is configured to evaluate a position of the grain transfer element relative to the receiving container, and the processor provides a perceptible indication to move the grain cart to position the grain transfer element relative to the receiving container based at least in part on the position of the grain transfer element relative to the receiving container.

33. The control system of claim 26, wherein the processor is configured to evaluate the position of the grain transfer element relative to the detected portion of the upper surface, and
the processor provides a perceptible indication to move the supplying container to position the grain transfer element relative to the receiving container based at least in part on the position of the grain transfer element relative to the detected portion of the upper surface.

34. The control system of claim 26, wherein at least one of the grain cart or the receiving container includes a scale element configured to detect a weight of the grain in at least one of the grain cart or the receiving container, and
wherein the processor is configured to direct the transfer of grain based at least in part on the weight of the grain in at least one of the grain cart or the receiving container.

35. The control system of claim 26, wherein the receiving container is divided into a plurality of compartments separated by one or more partitions and includes a scale element configured to detect a weight of the grain in at least one of the compartments,
wherein the at least one first sensor is configured to detect at least a portion of the one or more partitions, and
wherein the processor is configured to direct the transfer of grain based at least in part on the weight of the grain in at least one of the compartments.

36. The control system of claim 26, wherein the receiving container is divided into a plurality of compartments separated by one or more partitions,
wherein the at least one first sensor is configured to detect at least a portion of the one or more partitions,
wherein the grain cart includes a scale element configured to detect a weight of the grain in the grain cart, and
wherein the processor is configured to direct the transfer of grain based at least in part on the weight of the grain transferred into at least one of the compartments.

37. The control system of claim 26, wherein the grain transfer element includes a grain transfer control element configured to adjust a grain transfer rate, and
wherein the processor is configured to control the grain transfer control element to adjust the grain transfer rate.

38. The control system of claim 37, wherein the grain transfer control element comprises a movable gate operatively interposing a supplying container grain cart and the grain transfer element, and the processor is configured to direct positioning of the movable gate.

39. The control system of claim 26, wherein the receiving container is divided into compartments separated by one or more partitions,
wherein the first sensor is configured to detect at least a portion of a partition, and
wherein the controlled operation of the grain transfer element is based at least in part on the detected portion of the partition.

40. The control system of claim 26, wherein the receiving container includes one or more cross members,
wherein the at least one first sensor is configured to detect at least a portion of the cross members, and
wherein the controlled operation of the grain transfer element is based at least in part on the detected portion of the cross members.

41. A grain cart, comprising:
the control system of claim 26;
a supplying container;
a grain transfer element configured to transfer grain from the supplying container to the receiving container; and
a control spout coupled to the grain transfer element and configured to direct a stream of discharged grain.

42. A method of operating an automated grain unloading control system, the method comprising:
operating at least one first sensor to detect at least a portion of a receiving container divided into compartments separated by one or more partitions;
operating the at least one first sensor to detect at least a portion of the one or more partitions;
operating the at least one first sensor to detect at least a portion of an upper surface of a grain mound in the receiving container;
receiving a maximum weight limit of a compartment;
operating at least one second sensor to detect an orientation of a grain transfer element;
transferring grain from a supplying container to the receiving container based at least in part on a comparison of the detected portion of the receiving container, the detected portion of the one or more partitions, the detected portion of the upper surface, and the orientation of the grain transfer element;
detecting a weight of grain unloaded into a compartment; and
stopping the transfer of grain upon determining that the weight of grain unloaded into the compartment has reached the weight limit of the compartment.

43. The method of claim 42, further comprising:
detecting an interface between an upper surface of a grain mound in the receiving container and a wall of the receiving container;
detecting at least a portion of an upper edge of the wall; and
determining a plurality of freeboards by calculating a plurality of vertical distances between the detected interface and the detected portion of the upper edge of the wall.

44. The method of claim 43, further comprising:
determining a minimum freeboard by calculating a vertical distance between a highest point of the detected interface and a lowest point of the detected portion of the upper edge;
determining a maximum freeboard by calculating a vertical distance between a lowest point of the detected interface and a highest point of the detected portion of the upper edge; and
directing the transfer of grain toward a portion of the receiving container with the maximum freeboard.

45. The method of claim 43, further comprising at least one of slowing down or stopping transferring grain upon determining that the freeboard is less than a predetermined freeboard minimum limit.

46. The method of claim 42, further comprising preventing a discharge of grain if the grain would not be discharged into the receiving container.

47. The method of claim 42, further comprising:
receiving a maximum unload weight limit;
detecting a weight of grain unloaded; and
stopping transferring grain upon determining that the weight of grain unloaded has reached the maximum unload weight limit.

48. The method of claim 42, further comprising providing a perceptible indication to move the supplying container to position the grain transfer element relative to the receiving container.

49. The method of claim 42, wherein the grain transfer element includes a control spout, and the method further comprises moving the control spout to direct the stream of discharged grain laterally farther away from the supplying container and laterally nearer to the supplying container.

50. The method of claim 42, wherein the grain transfer element includes a control spout, and the method further comprises moving the control spout to direct the stream of discharged grain forwardly and rearwardly with respect to the supplying container.

51. The method of claim 42, wherein the receiving container is divided into compartments separated by one or more partitions,
the method further comprises:
detecting at least a portion of a partition; and
transferring grain from the supplying container to the receiving container based at least in part on the detected portion of the partition.

52. The method of claim 42, wherein the receiving container includes one or more cross members,
the method further comprises:
detecting at least a portion a cross member; and
transferring grain from the supplying container to the receiving container based at least in part on the detected portion of the cross member.

53. The method of claim 42, further comprising:
at least one of slowing or stopping the transfer of grain; and
providing a perceptible indication of the cause of the at least one of slowing or stopping of the transfer of grain.

54. The method of claim 42, further comprising:
at least one of slowing or stopping the transfer of grain; and
providing a perceptible indication of actions to perform to resume the transfer of grain.

55. An automated grain unloading control system for a supplying container with a grain transfer element configured to transfer grain from the supplying container to a receiving container, the control system comprising:
one or more sensors configured to detect an orientation of the grain transfer element, at least a portion of the receiving container, at least a portion of an upper surface of a grain mound in the receiving container, an interface of an upper surface of a grain mound in the receiving container and a wall of the receiving container, and at least a portion of an upper edge of the wall; and
a processor configured to compare the detected portion of the receiving container, the detected portion of the upper surface, and the orientation of the grain transfer element, and control the operation of the grain transfer element to direct a transfer of grain from the supplying container to the receiving container based at least in part on a result of the comparison of the detected portion of the receiving container, the detected portion of the upper surface, and the orientation of the grain transfer element,
wherein the processor is configured to determine a minimum freeboard by calculating a vertical distance between a highest point of the detected interface and a lowest point of the detected portion of the upper edge,
wherein the processor is configured to determine a maximum freeboard by calculating a vertical distance between a lowest point of the detected interface and a highest point of the detected portion of the upper edge, and
wherein the processor is configured to direct the transfer of grain toward a portion of the receiving container with the maximum freeboard.

56. The control system of claim 55, wherein the grain transfer element includes a control spout configured to direct a stream of discharged grain, and
wherein the one or more sensors are configured to detect an orientation of the spout.

57. The control system of claim 56, wherein the control spout is movable to direct the stream of discharged grain laterally farther away from the supplying container and laterally nearer to the supplying container.

58. The control system of claim 56, wherein the control spout is movable to direct the stream of discharged grain forwardly and rearwardly with respect to the supplying container.

59. The control system of claim 56, wherein the processor is configured to control the orientation of the control spout to direct the stream of discharged grain.

60. The control system of claim 55, wherein the processor is configured to prevent a discharge of grain via the grain transfer element if the processor determines that the grain would not be discharged into the receiving container.

61. The control system of claim 55, wherein the processor is configured to provide a perceptible indication to move the supplying container to position the grain transfer element relative to the receiving container.

62. The control system of claim 55, wherein the processor is configured to evaluate a position of the grain transfer element relative to the receiving container, and
wherein the processor provides a perceptible indication to move the supplying container to position the grain transfer element relative to the receiving container based at least in part on the position of the grain transfer element relative to the receiving container.

63. The control system of claim 55, wherein the processor is configured to evaluate the position of the grain transfer element relative to the detected portion of the upper surface, and
wherein the processor provides a perceptible indication to move the supplying container to position the grain transfer element relative to the receiving container based at least in part on the position of the grain transfer element relative to the detected portion of the upper surface.

64. The control system of claim 55, wherein at least one of the supplying container or the receiving container includes a scale element configured to detect a weight of the grain in at least one of the supplying container or the receiving container, and
wherein the processor is configured to direct the transfer of grain based at least in part on the weight of the grain in at least one of the supplying container or the receiving container.

65. The control system of claim 55, wherein the receiving container is divided into a plurality of compartments separated by one or more partitions and includes a scale element configured to detect a weight of the grain in at least one of the compartments, and
the processor is configured to direct the transfer of grain based at least in part on the weight of the grain in at least one of the compartments.

66. The control system of claim 55, wherein the receiving container is divided into a plurality of compartments separated by one or more partitions,
the supplying container includes a scale element configured to detect a weight of the grain in the supplying container, and
the processor is configured to direct the transfer of grain based at least in part on the weight of the grain transferred into at least one of the compartments.

67. The control system of claim 55, wherein the grain transfer element includes a grain transfer control element configured to adjust a grain transfer rate, and
wherein the processor is configured to control the grain transfer control element to adjust the grain transfer rate.

68. The control system of claim 67, wherein the grain transfer control element comprises a movable gate operatively interposing the supplying container and the grain transfer element, and the processor is configured to direct positioning of the movable gate.

69. The control system of claim 55, wherein the receiving container is divided into compartments separated by one or more partitions,
wherein the one or more sensors are configured to detect at least a portion of a partition, and
wherein the controlled operation of the grain transfer element is based at least in part on the detected portion of the partition.

70. The control system of claim 55, wherein the receiving container includes one or more cross members,
wherein the one or more sensors are configured to detect at least a portion of the cross members, and
wherein the controlled operation of the grain transfer element is based at least in part on the detected portion of the cross members.

71. A grain cart, comprising:
the control system of claim 55;
a supplying container; and
a grain transfer element configured to transfer grain from the supplying container to a receiving container.
